(19) United States
(12) Patent Application Publication
(10) Pub. No.: US 2026/0170383 A1
(43) Pub. Date: Jun. 18, 2026

(54) TECHNOLOGIES FOR PHOTONIC INTEGRATED CIRCUITS FOR QUBIT CONTROL AND READOUT

(71) Applicant: Intel Corporation, Santa Clara, CA (US)

(72) Inventors: Bishnu Prasad Patra, Hillsboro, OR (US); Xiaoxi Wang, Mountain View, CA (US); Stefano Pellerano, Beaverton, OR (US); James E. Jaussi, El Dorado Hills, CA (US)

(73) Assignee: Intel Corporation, Santa Clara, CA (US)

(21) Appl. No.: 18/977,500

(22) Filed: Dec. 11, 2024

(51) Int. Cl. G06N 10/60

(52) U.S. Cl. CPC G06N 10/60

(57) ABSTRACT

Technologies for various approaches to photonic qubit control and readout are disclosed. In an illustrative embodiment, optical fiber carries optical pulses to a quantum processor. The optical pulses are directed to photodiodes. One photodiode has its anode coupled to a qubit gate, and one photodiode has its cathode coupled to the qubit gate. An optical pulse on the photodiode whose anode is coupled to the qubit gate add charges to the qubit gate, increasing the voltage on the qubit gate. An optical pulse on the photodiode whose cathode is coupled to the qubit gate removes charges from the qubit gate, decreasing the voltage. Additionally or alternatively, an output from a single-electron transistor coupled to a qubit can be used to drive a modulator. The modulator can modulate an optical signal, which can be measured to determine the state of the qubit.

### BACKGROUND

Quantum computers promise computational abilities that are not feasible with classical computing. One of many challenges in a spin-based quantum computing platform is scaling to a large number of control signals for a large number of qubits, both for control and for readout. A dedicated cable for each control and readout signal would lead to a large number of connections as well as a large thermal load for the quantum processor.

### BRIEF DESCRIPTION OF THE DRAWINGS

FIGS. 1A-1F illustrate various views of an example quantum dot device, in accordance with one embodiment.

FIG. 2 is a simplified block diagram of at least one embodiment of a quantum compute device.

FIG. 3 is a simplified block diagram of at least one embodiment of a portion of the quantum compute device of FIG. 2.

FIG. 4 is a simplified block diagram of at least one embodiment of a photonic system for interfacing with qubits in a quantum processor.

FIG. 5 is a simplified diagram of at least one embodiment of part of a photonic circuit for interfacing with qubits in a quantum processor.

FIG. 6 is a simplified diagram of at least one embodiment of part of a photonic circuit for interfacing with qubits in a quantum processor.

FIG. 7 is a simplified diagram of at least one embodiment of part of a photonic circuit for interfacing with qubits in a quantum processor.

FIG. 8 is a simplified block diagram of at least one embodiment of a photonic system for interfacing with qubits in a quantum processor.

FIG. 9 is a simplified diagram of at least one embodiment of part of a photonic circuit for interfacing with qubits in a quantum processor.

FIG. 10 is a simplified diagram of at least one embodiment of part of a photonic circuit for interfacing with qubits in a quantum processor.

FIG. 11 is a simplified diagram of at least one embodiment of part of a photonic circuit for interfacing with qubits in a quantum processor.

FIG. 12 is a simplified block diagram of at least one embodiment of an environment that may be established by the quantum compute device of FIG. 2.

FIG. 13 is a plot showing the intensity of a light source for one embodiment of the system of FIG. 4.

FIG. 14 is a plot showing voltage on a qubit gate for one embodiment of the system of FIG. 4.

FIG. 15 is a simplified flow diagram of at least one embodiment of a method for interfacing with a qubit that may be executed by the quantum compute device of FIG. 2.

FIG. 16 is a top view of a wafer and dies, in accordance with any of the embodiments disclosed herein.

FIG. 17 is a cross-sectional side view of an integrated circuit, in accordance with any of the embodiments disclosed herein.

FIGS. 18A-18D are perspective views of example planar, gate-all-around, and stacked gate-all-around transistors.

FIG. 19 is a cross-sectional side view of an integrated circuit device assembly, in accordance with any of the embodiments disclosed herein.

FIG. 20 is a block diagram of an example electrical device, in accordance with any of the embodiments disclosed herein.

### DETAILED DESCRIPTION

Aspects of the present disclosure include a quantum compute device with a quantum processor. In use, the quantum processor has several spin qubits defined in it. Various techniques described below can be used to interface with the spin qubits. In one embodiment, two photodiodes are connected to a quantum gate. One photodiode has the anode connected to the quantum gate, and the other photodiode has the cathode connected to the quantum gate. Modulated laser signals from outside the cryogenic stage are coupled to the photodiodes to add and remove charge from the quantum gate, allowing the voltage on the quantum gate to be controlled optically.

Additionally or alternatively, a voltage signal from a single-electron transistor coupled to a qubit is coupled to an optical modulator. An optical signal passes through the modulator and is modulated based on the voltage signal from the single-electron transistor. Multiple signals can be carried by a single fiber for both qubit control and qubit readout. The optical fiber can have a low passive heat load on the cryogenic stage as well as low-power qubit control and readout and high isolation between channels. In some embodiments, the passive heat load for an optical cable can be 1,000 less than a coaxial cable, and the active power dissipation for optical control can be 10 times less than an electrical cable.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, a substrate assembly feature, such as a through width, that is described as having substantially a listed dimension can vary within a few percent of the listed dimension.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

As used herein, the terms “upper”/“lower” or “above”/“below” may refer to relative locations of an object (e.g., the surfaces described above), especially in light of examples shown in the attached figures, rather than an absolute location of an object. For example, an upper surface of an apparatus may be on an opposite side of the apparatus from a lower surface of the object, and the upper surface may be facing upward generally only when viewed in a particular way. As another example, a first object above a second object may be on or near an “upper” surface of the second object rather than near a “lower” surface of the object, and the first object may be truly above the second object only when the two objects are viewed in a particular way.

References are made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

A quantum computer uses quantum-mechanical phenomena such as superposition and entanglement to perform computations, simulations, or other functions. In contrast to digital computers, which store data in one of two definite states (0 or 1), quantum computation uses quantum bits (qubits), which can be in superpositions of states. Qubits may be implemented using physically distinguishable quantum states of elementary particles such as electrons and photons. For example, the polarization of a photon may be used where the two states are vertical polarization and horizontal polarization. Similarly, the spin of an electron may have distinguishable states such as “up spin” and “down spin.” Qubits in quantum mechanical systems can be in a superposition of both states at the same time, a trait that is unique and fundamental to quantum computing.

Quantum computing systems execute algorithms containing quantum logic operations performed on qubits. In some cases, the result of the algorithm is not deterministic. The quantum algorithm may be repeated many times in order to determine a statistical distribution of results or in order to have a high likelihood of finding the correct answer. In some cases, a classical algorithm may be used to check if the quantum computer determined the correct result.

Qubits have been implemented using a variety of different technologies which are capable of manipulating and reading quantum states. These include but are not limited to quantum dot devices (single-qubit spin based, multi-qubit spin based, spatial based, exchange-coupling based, etc.), trapped-ion devices, superconducting quantum computers, optical lattices, nuclear magnetic resonance computers, solid-state NMR Kane quantum devices, electrons-on-helium quantum computers, cavity quantum electrodynamics (CQED) devices, molecular magnet computers, and fullerene-based ESR quantum computers, to name a few. Thus, while a quantum dot device is described below in relation to certain embodiments of the invention, the underlying principles of the invention may be employed in combination with any type of quantum computer, including, but not limited to, those listed above. The particular physical implementation used for qubits is not necessarily required for the embodiments of the invention described herein.

Quantum dots are small semiconductor particles, typically a few nanometers in size. Because of this small size, quantum dots operate according to the rules of quantum mechanics, having optical and electronic properties which differ from macroscopic entities. Quantum dots are sometimes referred to as “artificial atoms” to connote the fact that a quantum dot is a single object with discrete, bound electronic states, as is the case with atoms or molecules.

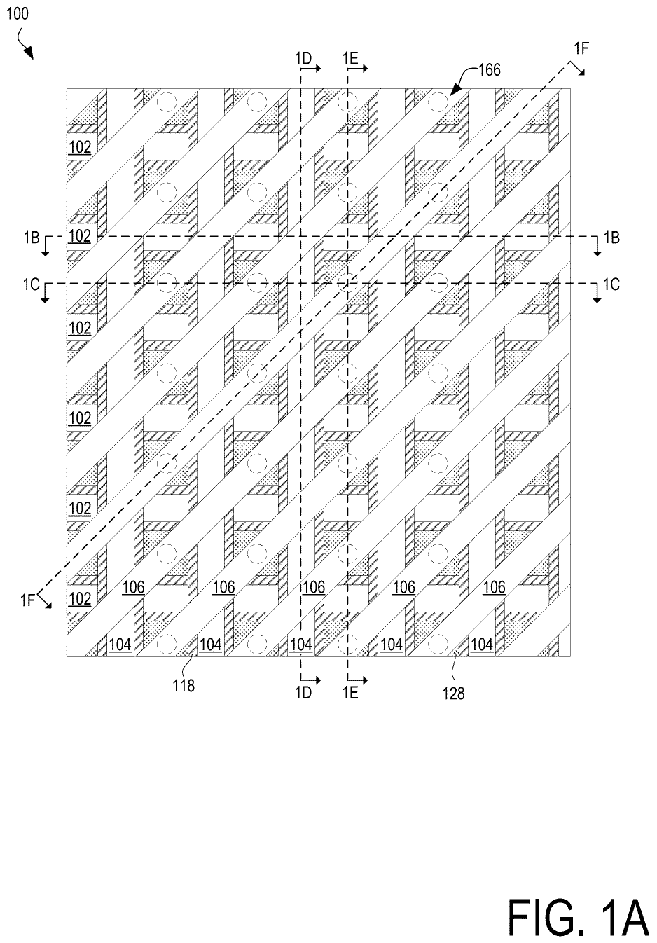

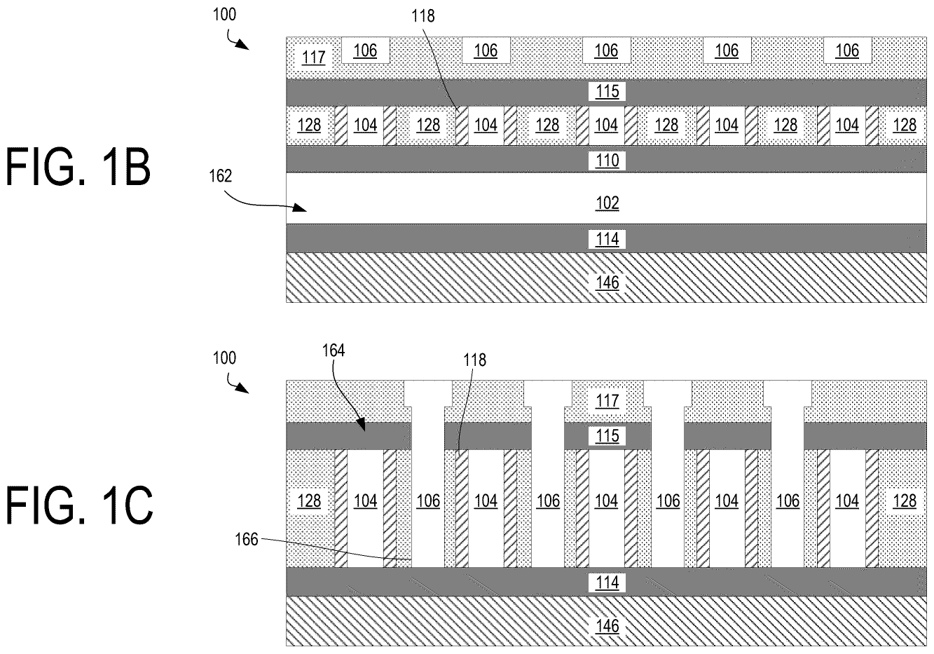

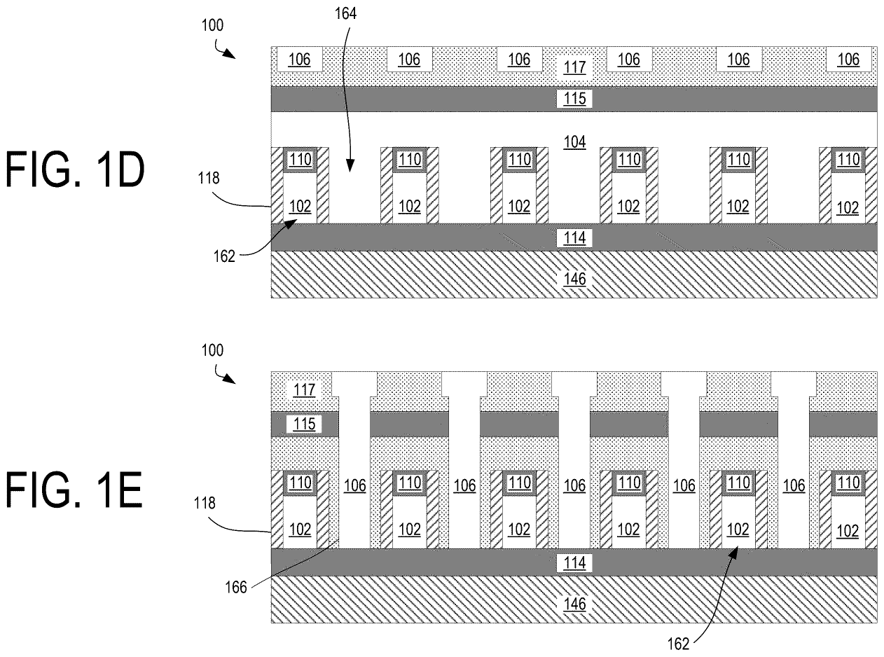

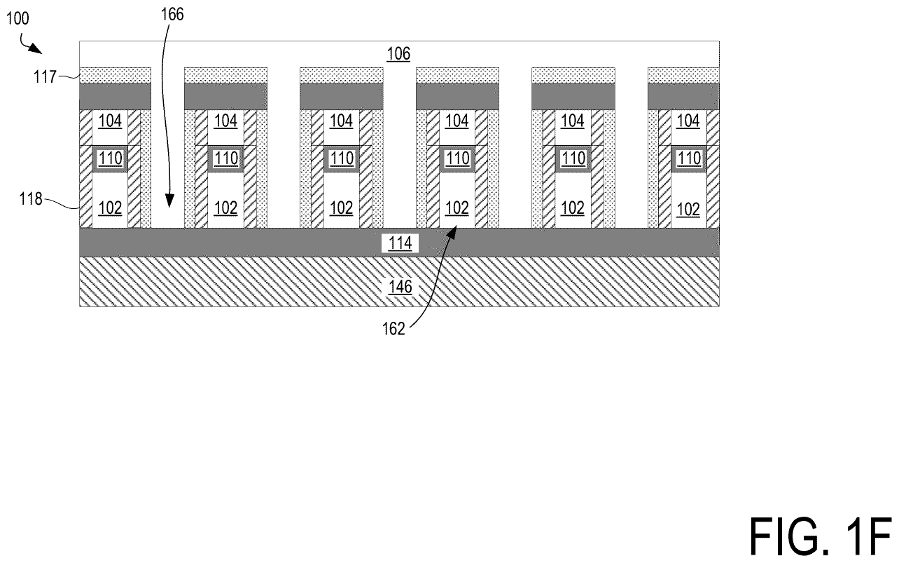

FIGS. 1A-1F are various views of a quantum dot device 100, which may be used with embodiments of the invention described below. FIG. 1A is a top view of a portion of the quantum dot device 100 with some of the materials removed so that the first gate lines 102, the second gate lines 104, and the third gate lines 106 are visible. Although many of the drawings and description herein may refer to a particular set of lines or gates as “barrier” or “quantum dot” lines or gates, respectively, this is simply for ease of discussion, and in other embodiments, the role of “barrier” and “quantum dot” lines and gates may be switched (e.g., barrier gates may instead act as quantum dot gates, and vice versa). FIGS. 1B-1F are side cross-sectional views of the quantum dot device 100 of FIG. 1A; in particular, FIG. 1B is a view through the section B-B of FIG. 1A, FIG. 1C is a view through the section C-C of FIG. 1A, FIG. 1D is a view through the section D-D of FIG. 1A, FIG. 1E is a view through the section E-E of FIG. 1A, and FIG. 1F is a view through the section F-F of FIG. 1A.

The quantum dot device 100 may include or be embodied as any suitable material, such as a die with a silicon substrate and various components patterned or built on the silicon substrate. The quantum dot device 100 of FIG. 1 may be operated in any of a number of ways. For example, in some embodiments, electrical signals such as voltages, currents, radio frequency (RF), and/or microwave signals, may be provided to one or more first gate line 102, second gate line 104, and/or third gate line 106 to cause a quantum dot (e.g., an electron spin-based quantum dot or a hole spin-based quantum dot) to form in a quantum well stack 146 under a third gate 166 of a third gate line 106. Electrical signals provided to a third gate line 106 may control the electrical potential of a quantum well under the third gates 166 of that third gate line 106, while electrical signals provided to a first gate line 102 (and/or a second gate line 104) may control the potential energy barrier under the first gates 162 of that first gate line 102 (and/or the second gates 164 of that second gate line 104) between adjacent quantum wells. Quantum interactions between quantum dots in different quantum wells in the quantum well stack 146 (e.g., under different quantum dot gates) may be controlled in part by the potential energy barrier provided by the barrier potentials imposed between them (e.g., by intervening barrier gates).

Generally, the quantum dot devices 100 disclosed herein may further include a source of magnetic fields (not shown) that may be used to create an energy difference in the states of a quantum dot (e.g., the spin states of an electron spin-based quantum dot) that are normally degenerate, and the states of the quantum dots (e.g., the spin states) may be manipulated by applying electromagnetic energy to the gates lines to create quantum bits capable of computation. The source of magnetic fields may be one or more magnet lines. Thus, the quantum dot devices 100 disclosed herein may, through controlled application of electromagnetic energy, be able to manipulate the position, number, and quantum state (e.g., spin) of quantum dots in the quantum well stack 146. Additionally or alternatively, in some embodiments, some or all of the interactions between qubits may be exchange interactions.

In the quantum dot device 100 of FIG. 1, a gate dielectric 114 may be disposed on a quantum well stack 146. A quantum well stack 146 may include at least one quantum well layer (not shown in FIG. 1) in which quantum dots may be localized during operation of the quantum dot device 100. The quantum well stack 146 may include, e.g., one or more alternating layers of silicon and silicon-germanium. The gate dielectric 114 may be any suitable material, such as a high-k material. Multiple parallel first gate lines 102 may be disposed on the gate dielectric 114, and spacer material 118 may be disposed on side faces of the first gate lines 102. In some embodiments, a patterned hardmask 110 may be disposed on the first gate lines 102 (with the pattern corresponding to the pattern of the first gate lines 102), and the spacer material 118 may extend up the sides of the hardmask 110, as shown. The first gate lines 102 may each be a first gate 162. Different ones of the first gate lines 102 may be electrically controlled in any desired combination (e.g., each first gate line 102 may be separately electrically controlled, or some or all the first gate lines 102 may be shorted together in one or more groups, as desired).

Multiple parallel second gate lines 104 may be disposed over and between the first gate lines 102. As illustrated in FIG. 1, the second gate lines 104 may be arranged perpendicular to the first gate lines 102. The second gate lines 104 may extend over the hardmask 110, and may include second gates 164 that extend down toward the quantum well stack 146 and contact the gate dielectric 114 between adjacent ones of the first gate lines 102, as illustrated in FIG. 1D. In some embodiments, the second gates 164 may fill the area between adjacent ones of the first gate lines 102/spacer material 118 structures; in other embodiments, an insulating material (not shown) may be present between the first gate lines 102/spacer material 118 structures and the proximate second gates 164. In some embodiments, spacer material 118 may be disposed on side faces of the second gate lines 104; in other embodiments, no spacer material 118 may be disposed on side faces of the second gate lines 104. In some embodiments, a hardmask 115 may be disposed above the second gate lines 104. Multiple ones of the second gates 164 of a second gate line 104 are electrically continuous (due to the shared conductive material of the second gate line 104 over the hardmask 110). Different ones of the second gate lines 104 may be electrically controlled in any desired combination (e.g., each second gate line 104 may be separately electrically controlled, or some or all the second gate lines 104 may be shorted together in one or more groups, as desired). Together, the first gate lines 102 and the second gate lines 104 may form a grid, as depicted in FIG. 1.

Multiple parallel third gate lines 106 may be disposed over and between the first gate lines 102 and the second gate lines 104. As illustrated in FIG. 1, the third gate lines 106 may be arranged diagonal to the first gate lines 102, and diagonal to the second gate lines 104. In particular, the third gate lines 106 may be arranged diagonally over the openings in the grid formed by the first gate lines 102 and the second gate lines 104. The third gate lines 106 may include third gates 166 that extend down to the gate dielectric 114 in the openings in the grid formed by the first gate lines 102 and the second gate lines 104; thus, each third gate 166 may be bordered by two different first gate lines 102 and two different second gate lines 104. In some embodiments, the third gates 166 may be bordered by insulating material 128; in other embodiments, the third gates 166 may fill the openings in the grid (e.g., contacting the spacer material 118 disposed on side faces of the adjacent first gate lines 102 and the second gate lines 104, not shown). Additional insulating material 117 may be disposed on and/or around the third gate lines 106. Multiple ones of the third gates 166 of a third gate line 106 are electrically continuous (due to the shared conductive material of the third gate line 106 over the first gate lines 102 and the second gate lines 104). Different ones of the third gate lines 106 may be electrically controlled in any desired combination (e.g., each third gate line 106 may be separately electrically controlled, or some or all the third gate lines 106 may be shorted together in one or more groups, as desired).

Although FIGS. 1A-F illustrate a particular number of first gate lines 102, second gate lines 104, and third gate lines 106, this is simply for illustrative purposes, and any number of first gate lines 102, second gate lines 104, and third gate lines 106 may be included in a quantum dot device 100. Other examples of arrangements of first gate lines 102, second gate lines 104, and third gate lines 106 are possible. Electrical interconnects (e.g., vias and conductive lines) may contact the first gate lines 102, second gate lines 104, and third gate lines 106 in any desired manner.

Not illustrated in FIG. 1 are accumulation regions that may be electrically coupled to the quantum well layer of the quantum well stack 146 (e.g., laterally proximate to the quantum well layer). The accumulation regions may be spaced apart from the gate lines by a thin layer of an intervening dielectric material. The accumulation regions may be regions in which carriers accumulate (e.g., due to doping, or due to the presence of large electrodes that pull carriers into the quantum well layer), and may serve as reservoirs of carriers that can be selectively drawn into the areas of the quantum well layer under the third gates 166 (e.g., by controlling the voltages on the quantum dot gates, the first gates 162, and the second gates 164) to form carrier-based quantum dots (e.g., electron or hole quantum dots, including a single charge carrier, multiple charge carriers, or no charge carriers). In other embodiments, a quantum dot device 100 may not include lateral accumulation regions, but may instead include doped layers within the quantum well stack 146. These doped layers may provide the carriers to the quantum well layer. Any combination of accumulation regions (e.g., doped or non-doped) or doped layers in a quantum well stack 146 may be used in any of the embodiments of the quantum dot devices 100 disclosed herein.

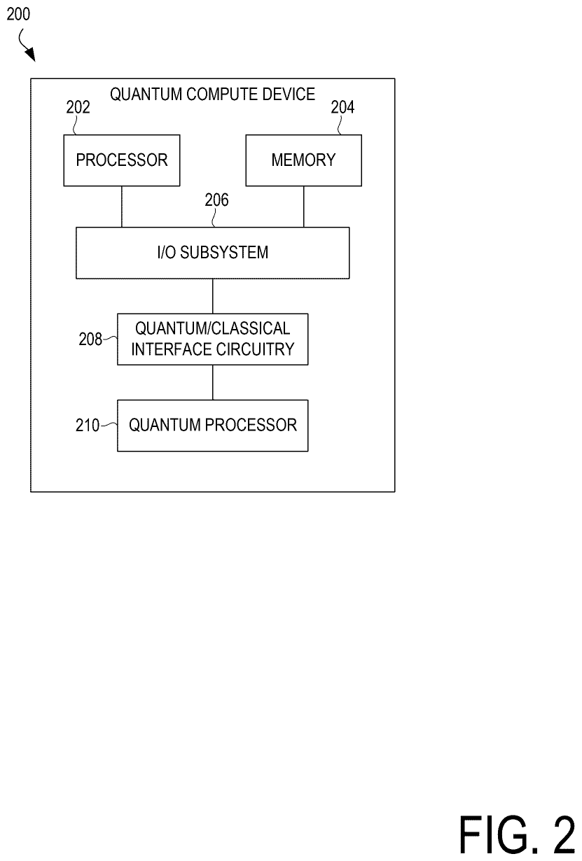

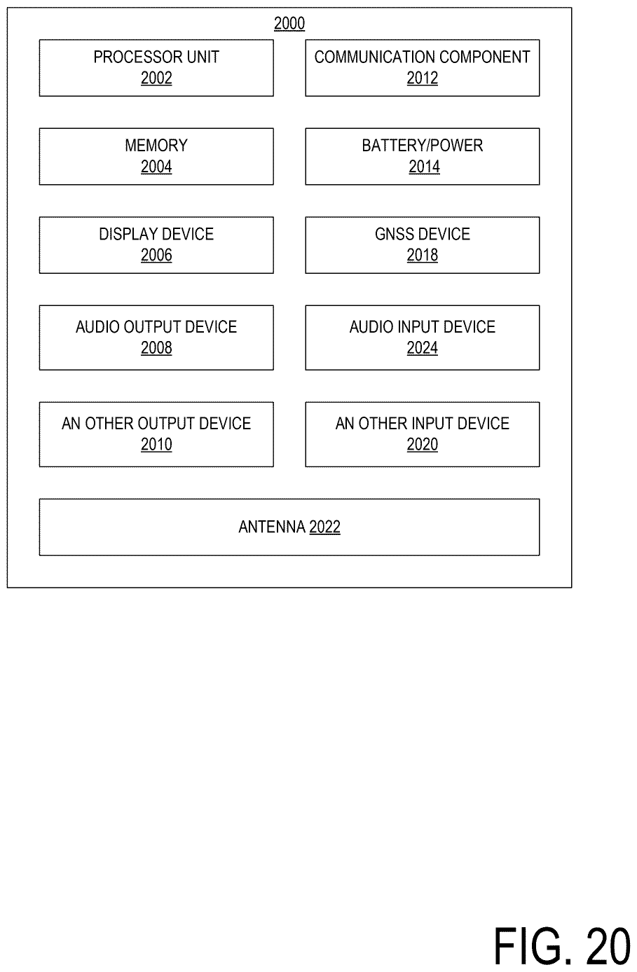

Referring now to FIG. 2, a simplified block diagram of a quantum compute device 200 is shown. In some embodiments, the quantum compute device 200 may include the quantum dot devices 100 described above in regard to FIGS. 1A-1F. The quantum compute device 200 may be embodied as or included in any type of compute device. For example, the quantum compute device 200 may include or otherwise be included in, without limitation, a server computer, an embedded computing system, a System-on-a-Chip (SoC), a multiprocessor system, a processor-based system, a consumer electronic device, a desktop computer, a laptop computer, a network device, a networked computer, a distributed computing system, and/or any other computing device. The illustrative quantum compute device 200 includes a processor 202, a memory 204, an input/output (I/O) subsystem 206, a quantum/classical interface circuitry 208, and a quantum processor 210. In some embodiments, one or more of the illustrative components of the quantum compute device 200 may be incorporated in, or otherwise form a portion of, another component. For example, the memory 204, or portions thereof, may be incorporated in the processor 202 in some embodiments. In some embodiments, the quantum compute device 200 may be embodied as the electrical device 2000 described below in regard to FIG. 20 or may include any suitable component of the electrical device 2000.

In some embodiments, the quantum compute device 200 may be located in a data center with other compute devices, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves), a micro data center, etc. In some embodiments, the quantum compute device 200 may receive jobs over a network (such as the Internet) to perform on the quantum processor 210. The quantum compute device 200 may perform the jobs on the quantum processor 210 and send the results back to the requesting device.

The processor 202 may be embodied as any type of processor capable of performing the functions described herein. For example, the processor 202 may be embodied as a single or multi-core processor(s), a single or multi-socket processor, a digital signal processor, a graphics processor, a neural network compute engine, an image processor, a microcontroller, or other processor or processing/controlling circuit. The processor 202 may include multiple processor cores. In some embodiments, the processor 202 supports quantum extensions to an existing ISA of the processor/core, allowing instructions that interface with the quantum/classical interface circuitry 208 and the quantum processor 210.

The memory 204 may be embodied as any type of volatile or non-volatile memory or data storage capable of performing the functions described herein. In operation, the memory 204 may store various data and software used during operation of the quantum compute device 200, such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the quantum compute device 200. For example, the I/O subsystem 206 may be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations. The I/O subsystem 206 may connect various internal and external components of the quantum compute device 200 to each other with use of any suitable connector, interconnect, bus, protocol, etc., such as an SoC fabric, PCIe®, USB2, USB3, USB4, NVMe®, Thunderbolt®, Compute Express Link (CXL), and/or the like. In some embodiments, the I/O subsystem 206 may form a portion of a system-on-a-chip (SoC) and be incorporated, along with the processor 202 and the memory 204 and other components of the quantum compute device 200 on a single integrated circuit chip.

The quantum/classical interface circuitry 208 is configured to interface with both classical components of the quantum compute device 200, such as the processor 202 and memory 204, as well as the quantum processor 210. The quantum/classical interface circuitry 208 may include a variety of analog or digital circuitry, such as analog-to-digital converters, digital-to-analog converters, high gain amplifiers, low noise amplifiers, cryogenic amplifiers, transimpedance-amplifiers, differential amplifiers, lasers, light-emitting diodes, modulators, photonic integrated circuit (PIC) dies, electronic integrated circuit (EIC) dies, photodetectors, field-programmable gate arrays (FPGAs), classical processors, application-specific integrated circuits (ASICs), signal conditioning circuitry, etc. In some embodiments, some or all of the quantum/classical interface circuitry 208 may be embodied as or otherwise included in other components of the quantum compute device 200, such the processor 202 and memory 204. In some embodiments, some or all of the quantum/classical interface circuitry 208 may be inside of a refrigerator, such as a dilution refrigerator, a magnetic refrigerator, a helium-4 and/or helium-3 refrigerator, etc. Some or all of the components of the quantum/classical interface circuitry 208 may be at any suitable temperature, such as 10 millikelvin, 100 millikelvin, 4 Kelvin, 20 Kelvin, 77 Kelvin, room temperature or above, or anywhere in between.

The quantum processor 210 is configured to operate one or more qubits. The qubits may be any suitable type of qubit, such as a quantum dot spin qubit described above in regard to FIGS. 1A-1F. In other embodiments, the qubits may be, e.g., charge qubits, transmon qubits, microwave qubits, superconducting qubits, or any other suitable type of qubits. The quantum processor 210 may include any suitable number of physical or logical qubits, such as 1-10⁶. In the illustrative embodiment, some or all of the quantum processor 210 is in a refrigerator such as a dilution refrigerator. In particular, in the illustrative embodiment, the qubits are held at a temperature of about 10 millikelvin. In other embodiments, the qubits may be held at any suitable temperature, such as 1-100 millikelvin or higher, depending on the temperature sensitivity of the particular qubit in use.

The quantum processor 210 may be able to control the various qubits in various ways, such as by performing single-qubit gates, two-qubit gates, three-qubit gates, error correction operations, transferring a state from one type of qubit to another, measuring some, any, or all of the qubits, initializing some, any, or all of the qubits, etc.

The quantum compute device 200 may include additional components not shown in FIG. 2, such as one or more data storage devices, a network interface controller, one or more peripheral devices, etc.

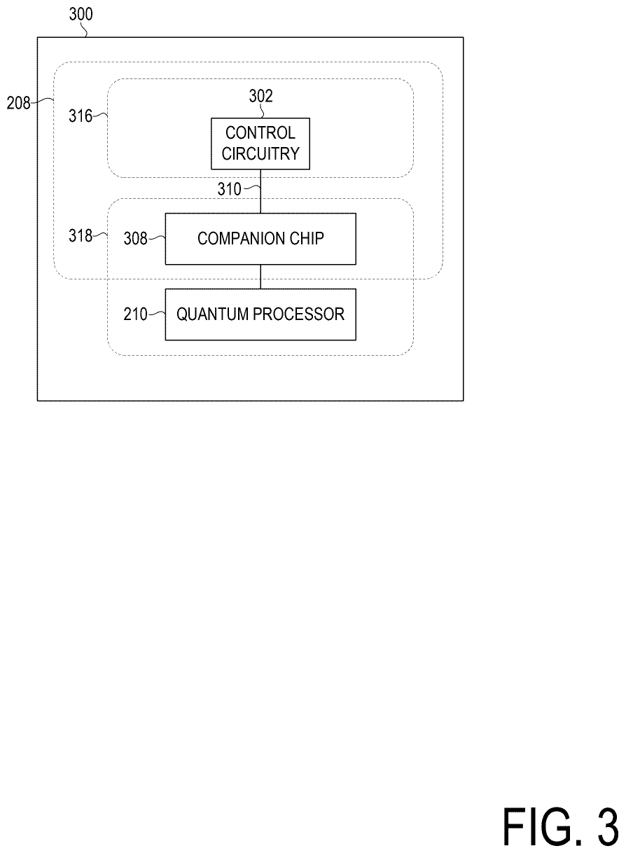

Referring now to FIG. 3, in one embodiment, the quantum processor 210 and some or all of the quantum/classical interface circuitry 208 may be in a cryogenic refrigerator 300. The quantum/classical interface circuitry 208 includes control circuitry 302 that can interface with a companion chip 308. The control circuitry 302 may be connected to the companion chip 308 by one or more wires 310. The wires 310 may be embodied as one or more cables, buses, twisted wire pairs, etc. In some embodiments, the wires 310 may include optical cables.

In the illustrative embodiment, the control circuitry 302 may be in a first stage 316 of the cryogenic refrigerator 300, and the companion chip 308 and the quantum processor 210 may be in a second stage 318 of the cryogenic refrigerator 300. In some embodiments, some or all of the control circuitry 302 may be external to the cryogenic refrigerator 300. In the illustrative embodiment, the first stage 316 is held at a temperature of about 4 Kelvin, and the second stage 318 is held at a temperature of about 20 millikelvin. In other embodiments, the first stage 316 may be held at, e.g., 1-77 Kelvin, and the second stage 318 may be held at, e.g., 10-100 millikelvin. In some embodiments, the various components of FIG. 3 may be in different stages than that shown in FIG. 3 and/or the refrigerator 300 may include additional stages, such as one or more stages at a higher or lower temperature than the first stage 316 and/or the second stage 318. The cryogenic refrigerator 300 may be any suitable refrigerator with active or passive cooling, such as a dilution refrigerator, a magnetic refrigerator, a helium-4 and/or helium-3 refrigerator, etc.

In use and as described in more detail below, the control circuitry 302 receives instructions from another component of the quantum compute device 200 (e.g., from the processor 202 or the memory 204). The instructions may be digital instructions, such as read from or write to memory, read from or write to a register, conditional branches, etc. The instructions may also be analog instructions, such as an instruction to generate or receive an analog pulse, set an analog voltage on a qubit, set a digital voltage on a multiplexer that selects a qubit, etc. The control circuitry 302 may send and receive digital and/or analog signals to the companion chip 308. Signals for multiple qubits may be sent on the wires 310 from the control circuitry 302 to the companion chip 308, and the companion chip 308 may demultiplex signals from the control circuitry 302, such as by using optical and/or electrical frequency multiplexing, temporal multiplexing, etc. As such, the control circuitry 302 may send and receive analog signals to a relatively large number of qubits over a relatively small number of wires 310. For example, for each wire 310 carrying analog signals to and from the control circuitry 302, the control circuitry 302 may control 2-100 qubits. Electrical and/or optical cables may carry signals between the companion chip 308 and the quantum processor 210. Additionally or alternatively, in some embodiments, the control circuitry 302 may send and receive analog and/or digital signals directly to or from the quantum processor 210, without necessarily going through the companion chip 308.

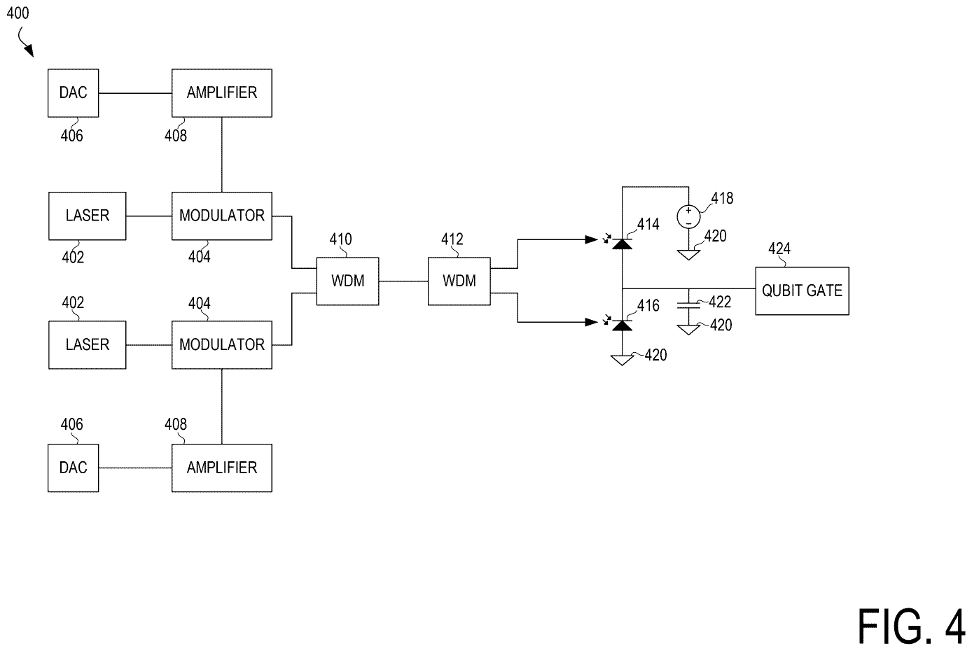

Referring now to FIG. 4, in one embodiment, a photonic system 400 for interfacing with a quantum processor 210 is shown. The system 400 includes lasers 402, modulators 404, digital-to-analog-converters (DACs) 406, amplifiers 408, wavelength-division multiplexers/demultiplexers (WDMs) 410, 412, and photodiodes 414, 416 connected to a qubit gate 424. In one embodiment, some of the components, such as the lasers 402, modulators 404, amplifiers 408, DACs 406, and multiplexers 410, are outside of the coldest cryogenic stage, such as at an intermediate stage or at ambient temperature. In such an embodiment, the demultiplexers 412, photodiodes 414, 416, and the qubit gate 424 are at the coldest cryogenic stage at, e.g., 20 millikelvin.

In use, the DACs 406 generate electrical pulses of a desired shape. The electrical pulses are amplified using the amplifiers 408 and sent to the modulators 404. The modulators 404 are used to module the lasers 402 and generate optical pulses. Optical pulses at different wavelengths are combined at the multiplexer 410 and sent on an optical cable to the demultiplexer 412 in the cryogenic stage.

The demultiplexed signals are sent to photodiodes 414, 416. In an illustrative embodiment, photodiode 414 has an anode connected to a qubit gate 424 and a cathode connected to a voltage source 418. In an illustrative embodiment, the voltage source 418 has a positive side connected to the cathode of the photodiode 414 and a negative side connected to a signal ground 420. Photodiode 416 has an anode connected to the qubit gate 424 and a cathode connected to signal ground 420.

The line connected to the qubit gate 424 may have an associated capacitance, represented by the capacitor 422. In an illustrative embodiment, the capacitor 422 is a parasitic capacitance and does not correspond to a physical capacitor. In another embodiment, the capacitor 422 may correspond to a physical capacitor. In an illustrative embodiment, with the photodiodes 414, 416 on a separate die from the qubit gate 424, parasitic capacitance may lead to an effective capacitor 422 with a capacitance of about 100 femtofarads. If the photodiodes 414, 416 are on the same die as the qubit gate 424, the parasitic capacitance may be lower at about 10 femtofarads. In other embodiments, the capacitance may be different values, such as 5-500 femtofarads.

In use, demultiplexed optical pulses can be sent independently to the photodiode 414 and the photodiode 416. When optical pulses reach the photodiode 414, current passes through the photodiode 414 from the voltage source 418 onto the capacitor 422, adding charge to the capacitor 422 and increasing the voltage on the qubit gate 424. When optical pulses reach the photodiode 416, current passes through the photodiode 414 from the capacitor 422 to the signal ground 420, removing charge from the capacitor 422 and decreasing the voltage on the qubit gate 424. In this manner, optical pulses can be used to control the voltage on the qubit gate 424.

In an illustrative embodiment, the photodiodes 414, 416 are slightly reverse biased by the voltage source 418, which increases the response time of the photodiodes 414, 416. For example, the voltage source 418 may apply a bias voltage of, e.g., 0-0.5 volts. In one embodiment, the voltage source 418 applies a bias voltage of 0.2 volts, leading to a bandwidth of about 1 gigahertz and a power dissipation of about 2 microwatts. In other embodiments, the power dissipation may be, e.g., 1-15 microwatts. It should be appreciated that the amount of reverse bias depends on the voltage of the capacitor 422, and the bias on the photodiodes 414, 416 may change depending on the voltage of the capacitor 422. In some embodiments, the photodiodes 414, 416 may be slightly forward biased some or all of the time, which may reduce energy consumption. For example, if a photodiode 414, 416 is forward biased an amount almost equal to the bandgap of the photodiode 414, 416, then most of the energy of the photons being absorbed are used to apply a reverse current to the voltage source 418, offsetting the energy being added to the system by the photon. In some embodiments, the voltage at the anode of the photodiode 416 may be something other than signal ground 420, such as −1 to 1 volt.

It should be appreciated that no high-power electronics, such as transimpedance amplifiers, are required in the cryogenic stage. Rather, each photon absorbed by the photodiode can add or remove an electron on the capacitor 422, allowing for low energy control of the voltage on the qubit gate 424. The noise on the qubit gate 424 can be relatively low. For example, simulations show an estimated noise less than 15 microvolt RMS voltage noise. In other embodiments, the voltage noise may be less than, e.g., 15-500 microvolts RMS voltage noise. In an illustrative embodiment, the photodiodes 414, 416 can be used to put an arbitrary voltage on the qubit gate 424 within a 300 millivolt range with a resolution of 10 microvolts. In other embodiments, the photodiodes 414, 416 can be used to put an arbitrary voltage on the qubit gate 424 within a 100-1,000 millivolt range with a resolution of 2-50 microvolts.

The lasers 402 may be any suitable laser, such as a laser integrated into a photonic integrated circuit (PIC) die. The lasers 402 may be semiconductor lasers, silicon lasers, III-V semiconductor lasers, and/or any other suitable type of laser. In an illustrative embodiment, the lasers 402 are O band, with a wavelength of, e.g., 1,260 nanometers to 1,360 nanometers. In other embodiments, other wavelengths may be used, such as C band, L band, S band, etc. In general, any suitable wavelength may be used, from, e.g., 600 nanometers to 10 micrometers. Of course, the wavelength for the lasers 402 are compatible with the sensitivity of the photodiodes 414, 416.

The modulator 404 may be any suitable modulator, such as a microring resonator, an electro-optic modulator, and/or the like. In an illustrative embodiment, the modulator 404 is a microring modulator on the same PIC die as the laser 402. In some embodiments, the current driving the laser 402 may be modulated directly, without a separate optical modulator 404.

The DAC 406 may be any suitable component to take a digital signal as an input and output an analog signal for controlling the modulator 404 or laser 402. In an illustrative embodiment, the output of the DAC 406 is provided to an amplifier 408. The amplifier 408 may be any suitable type of amplifier, such as a differential amplifier.

The multiplexer 410 may be any suitable type of multiplexer. In an illustrative embodiment, the multiplexer 410 is a microring resonator add/drop multiplexer that is integrated into the PIC die with the laser 402 and modulator 404. In other embodiments, a different multiplexer may be used, such as a discrete component.

The output of the multiplexer 410 may be coupled to an optical fiber. In an illustrative embodiment, a glass optical fiber is used. In other embodiments, other optical fibers may be used, such as plastic, chalcogenide, etc.

The demultiplexer 412 may be similar to the multiplexer 410. In an illustrative embodiment, the demultiplexer 412 may be integrated into a PIC die that is part of a quantum processor package. The output of the demultiplexer 412 is connected to the photodiodes 414, 416. Any suitable photodiodes 414, 416 may be used, such as silicon photodiodes, germanium photodiodes, III-V photodiodes, etc. In some embodiments, the photodiodes 414, 416 may be germanium photodiodes on a silicon-germanium substrate. In an illustrative embodiment, the photodiodes 414, 416 are integrated on the same PIC die as the demultiplexer 412, and the anodes and cathodes of the photodiodes 414, 416 are electrically coupled to an electronic integrated circuit (PIC) die that includes the qubits and the qubit gate 424. In an illustrative embodiment, the qubit gate 424 may be embodied as gate lines 102, 104, 106 described above in regard to FIG. 1. The qubit gate may be a plunger gate, barrier gate, and/or any other suitable gate that is used to control or create a spin qubit. In some embodiments, the optical components in the quantum processor package, such as the demultiplexer 412 and/or the photodiodes 414, 416 may be integrated onto the same die as the qubits.

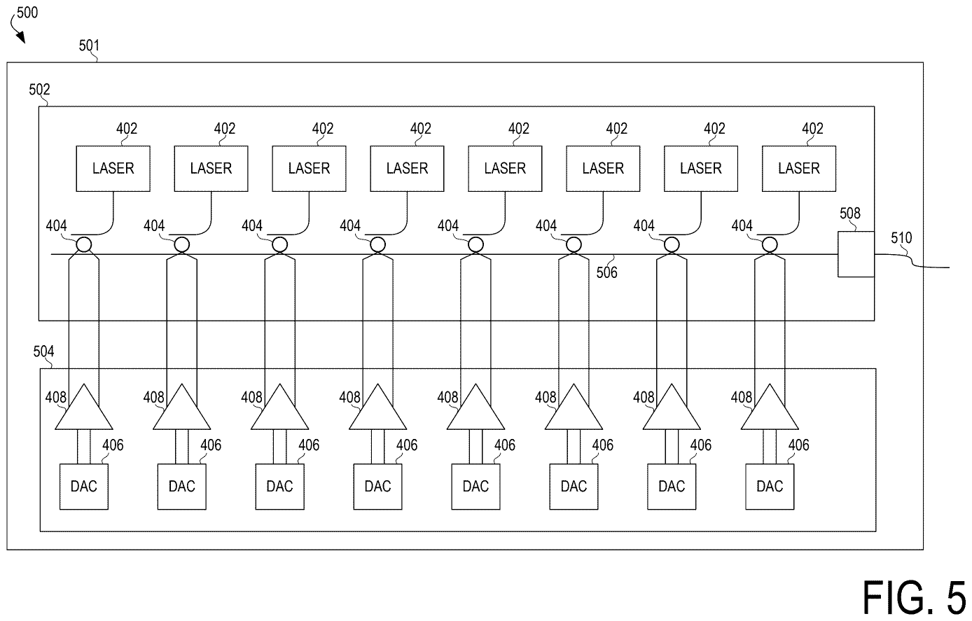

Referring now to FIG. 5, in one embodiment, an integrated circuit component 500 includes a circuit board 501, a photonic integrated circuit (PIC) die 502 and an electronic integrated circuit (EIC) die 504. The integrated circuit component 500 includes several of the features of the system 400, such as some or all of the components that may be at room temperature. The PIC die 502 includes lasers 402, which are coupled by waveguides to microring resonators that act as modulators 404. In an illustrative embodiment, the wavelength-selective modulators 404 act as the multiplexers 410 as well as the modulators 404. The modulators 404 are coupled to a bus waveguide 506 to carry several multiplexed optical signals. The bus waveguide 506 is coupled to an optical coupler 508, which is connected to an optical fiber 510. The optical fiber 510 may carry optical signals to and from the cryogenic stage. In the embodiment shown, the integrated circuit component 500 may include lasers 402, multiplexers 410, etc., to combine eight channels on one optical fiber 510 to control four qubit gates 424. In other embodiments, any suitable number of channels may be included on one optical fiber, such as 1-500.

The EIC die 504 includes DACs 406 and amplifiers 408. The amplifiers 408 are connected to the modulators 404 on the PIC die 502. The amplifiers 408 may be connected using traces on the EIC die 504, traces on the PIC die 502, traces on the circuit board 501, wire bonds, and/or the like. It should be appreciated that the PIC die 502, EIC die 504, and the integrated circuit component 500 may include additional components not shown, such as additional optical components, additional electrical components, additional dies, etc.

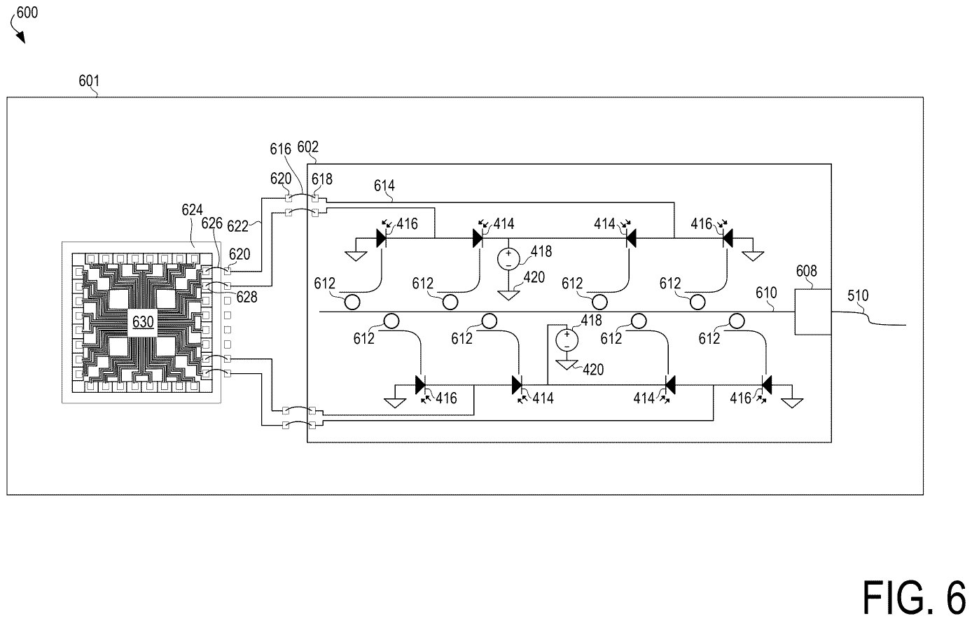

Referring now to FIG. 6, in one embodiment, a quantum processor package 600 includes a circuit board 601, a photonic integrated circuit (PIC) die 602, and a quantum processor die 624 with a qubit region 630. The quantum processor package 600 includes several of the features of the system 400, such as some or all of the components that may be at the coldest cryogenic stage of the quantum compute device 200. The PIC die 602 includes an optical coupler 608, which couples light from the optical fiber 510 to a bus waveguide 610. Microring resonators 612 act as demultiplexers 412, selecting pulses at a particular wavelength band and coupling them to a waveguide and one of the photodiodes 414, 416. The anode of each photodiode 414 and the cathode of each photodiode 416 is coupled to a qubit gate 424 on the quantum processor die 624. The photodiodes 414, 416 may be coupled to the quantum processor die 624 through traces 614 on the PIC die 602, pads 618 on the PIC die 602, wire bonds 616 from the pads 618 to pads 620 on the circuit board 601, traces 622 on the circuit board 601 to other pads 620 on the circuit board 601, wire bonds 626, pads 628 on the quantum processor die 624, and traces on the quantum processor die 624.

In the embodiment shown, the PIC die 602 may include microring resonators 612, photodiodes 414, 416, etc., to drive eight channels from one optical fiber 510 to control four qubit gates 424. In other embodiments, the PIC die 602 may include components to accept any suitable number of channels from one optical fiber 510, such as 1-500. In some embodiments, the PIC die 602 may interface with signals to drive photodiodes 414, 416 from more than one optical fiber 510 or more than one optical fiber core, such as 1-256 optical fibers 510, each of which may have 1-64 cores.

In an illustrative embodiment, the optical coupler 608 has dimensions of about 10 micrometers by 10 micrometers. The pads 618 may have a diameter of about 10 micrometers and a pitch of about 125 micrometers. The photodiodes 414, 416 may have a width of about 8 micrometers and a length of about 10 micrometers. The microring resonators 612 may have a diameter of about 10 micrometers.

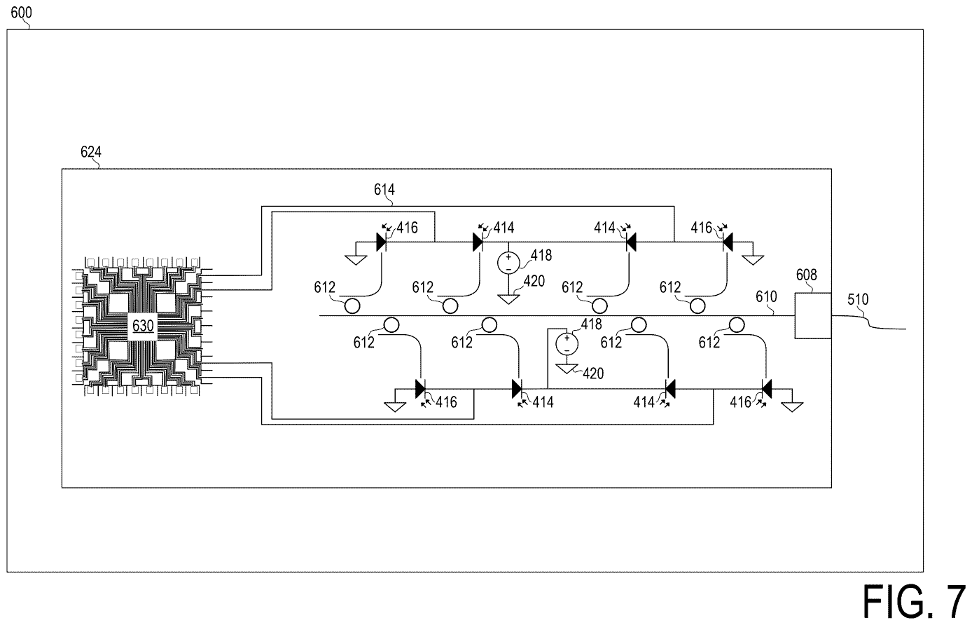

In an illustrative embodiment, some of the components on the quantum processor package 600 are on the PIC die 602, such as the photodiodes 414, 416, microring resonators 612, and waveguides 610, and other components are on a separate quantum processor die 624. In some embodiments, some or all of the components on the PIC die 602 may be integrated into the quantum processor die 624, such as the photodiodes 414, 416, microring resonators 612, and waveguides 610, etc., as shown in FIG. 7.

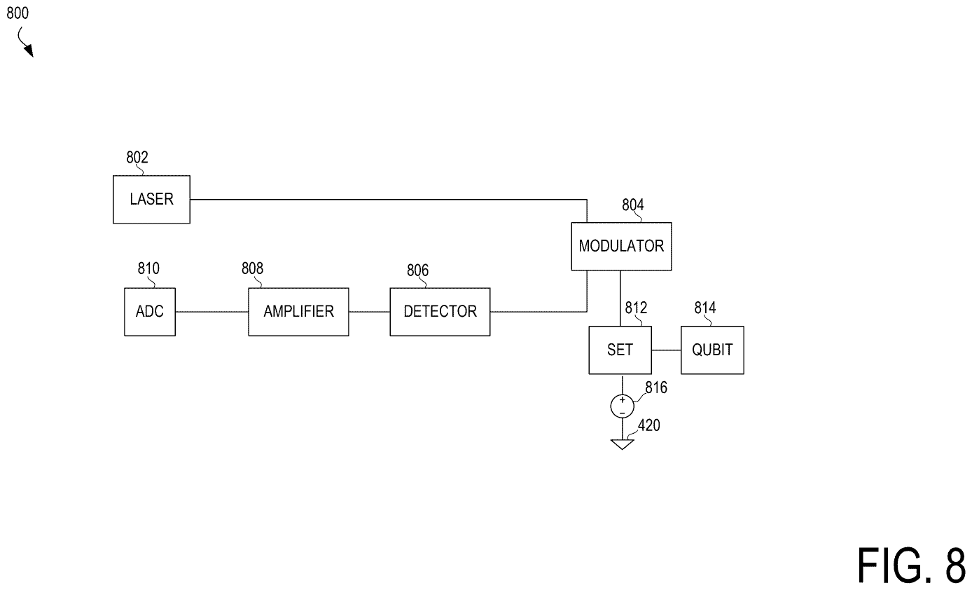

Referring now to FIG. 8, in one embodiment, a photonic system 800 for interfacing with a quantum processor 210 is shown. The system 800 includes a laser 802, modulator 804, detector 806, amplifier 808, and analog-to-digital converter (ADC) 810. The system also includes a qubit 814 (e.g., a qubit in the quantum processor 210) and a single-electron transistor (SET) 812 coupled to a voltage source 816, the qubit 814, and the modulator 804. In an illustrative embodiment, the laser 802, detector 806, amplifier 808, and ADC 810 are at room temperature, and the qubit 814, SET 812, and modulator 804 are at cryogenic temperatures.

In use, the qubit 814 is capacitively coupled to the gate of the single-electron transistor 812. As such, the state of electrons in the qubit 814 affects the voltage on the gate of the single-electron transistor 812. In one embodiment, when the spin qubit 814 is in a spin up state, the electron that forms the spin qubit 814 can transition out of the qubit 814 temporarily, changing for a period of time the resistance of the single-electron transistor 812 and the voltage on the modulator 804. The change of voltage on the modulator 804 may be relatively small, such as 100 microvolts, with an amperage of, e.g., 100 picoamps. The modulator 804 changes the intensity of the light from the laser 802, and the change in intensity is detected by the detector 806, amplifier 808, and ADC 810. The modulator 804 may change the intensity of the light in any suitable manner. In an illustrative embodiment, the output of the single-electron transistor 812 is connected to a p-n junction that forms part of the modulator 804. The output of the single-electron transistor 812 changes the carrier density at the PN junction, which changes the index of refraction, and changes the resonance of the microring modulator 804. The change in resonance results in a phase and/or amplitude change in the light in the waveguide and can be measured by the detector 806. In this manner, the signal from the qubit 814 can be read out optically, with no high-power components, such as amplifiers, in the cryogenic stage. As the laser is not dissipated in the cryogenic stage, the laser can be high enough intensity to clearly read the state of the qubit 814, such as 5 milliwatts.

The single-electron transistor 812 may be any suitable single-electron transistor, such as a single-electron transistor based on a semiconductor quantum dot. As used herein, a single-electron transistor includes few-electron transistors and does not necessarily operate in the single electron regime unless explicitly stated otherwise, despite the name. In the illustrative embodiment, the single-electron transistor 812 operates in the regime of approximately 100 electrons.

The laser 802 may be similar to the laser 402 described above. The detector 806 may be any suitable detector, such as the photodiodes 414, 416 described above. The amplifier 808 may be any suitable amplifier, such as a transimpedance amplifier.

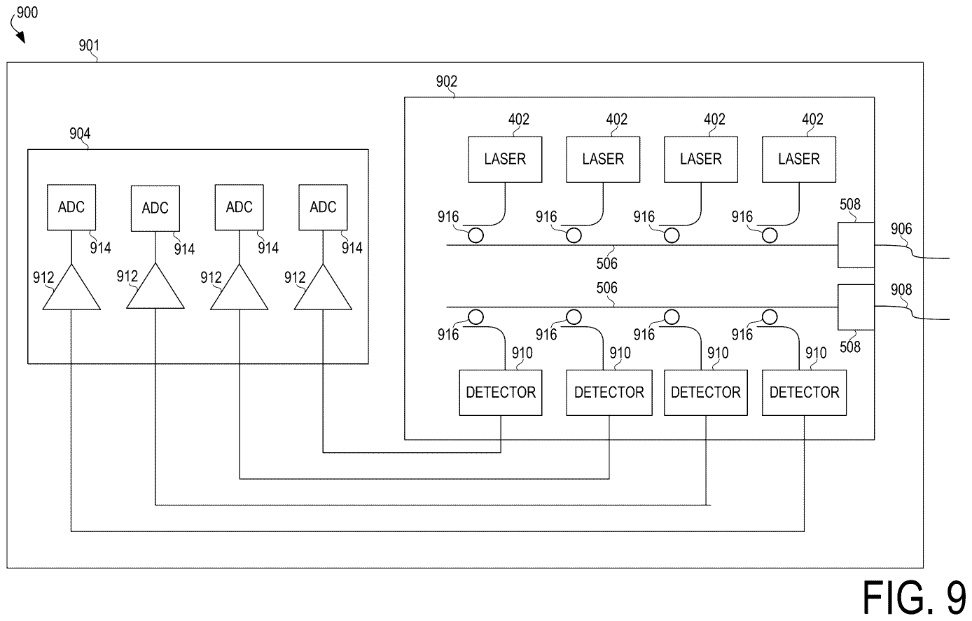

Referring now to FIG. 9, in one embodiment, an integrated circuit component 900 includes a circuit board 901, a photonic integrated circuit (PIC) die 902 and an electronic integrated circuit (EIC) die 904. The integrated circuit component 900 includes several of the features of the system 800, such as some or all of the components that may be at room temperature. The PIC die 902 includes lasers 402, which are coupled by waveguides to microring resonators that act as multiplexers. The multiplexers are coupled to a bus waveguide 506 to carry several multiplexed optical signals. The bus waveguide 506 is coupled to an optical coupler 508, which is connected to an optical fiber 906. The optical fiber 906 may carry optical signals to the cryogenic stage. Another optical fiber 908 carries optical signals from the cryogenic stage. The optical fiber 908 is connected to another optical coupler 508 and bus waveguide 506. Additional microring resonators 916 act as demultiplexers, sending a signal from a different channel through a waveguide to a detector 910. Each detector 910 is connected to an amplifier 912 and an ADC 914 on the EIC die 904.

In the embodiment shown, the integrated circuit component 900 may include lasers 402, microring resonators, etc., to combine and/or split four channels to and/or from one optical fiber 906 to perform a readout on four qubits 814. In other embodiments, any suitable number of channels may be included on one optical fiber, such as 1-500.

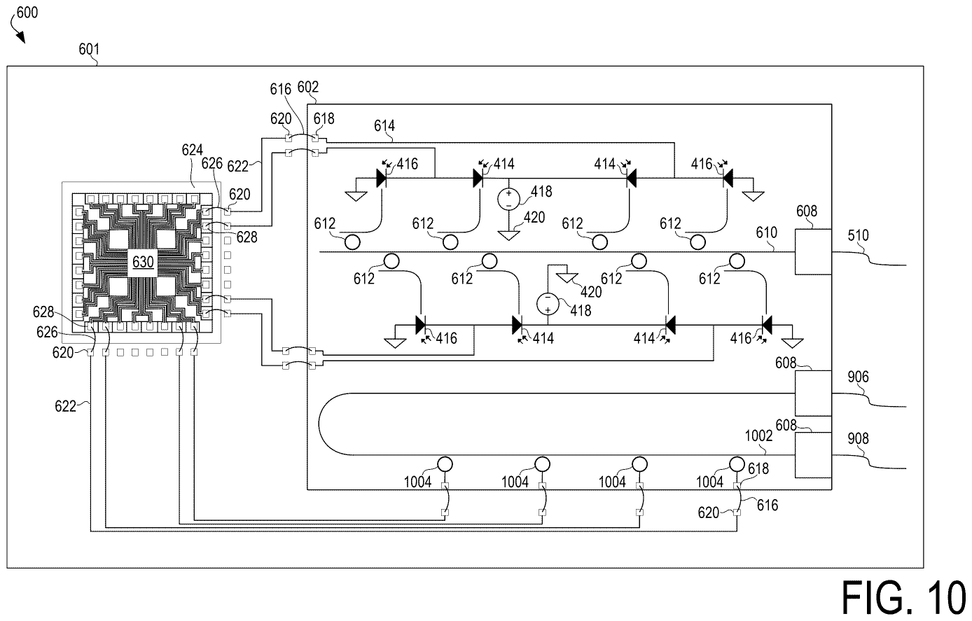

Referring now to FIG. 10, in one embodiment, a quantum processor package 600 includes a circuit board 601, a photonic integrated circuit (PIC) die 602 and a quantum processor die 624. The quantum processor package 600 may include several of the features of the quantum processor package 600 described above in regard to FIG. 6 and/or may include several of the features of the system 800, such as some or all of the components that may be at the coldest cryogenic stage of the quantum compute device 200. The PIC die 602 includes an optical couplers 608 coupled to the optical fibers 906, 908. The fibers 906, 908 are connected to a bus waveguide 1002. Wavelength-selective microring modulators 1004 can modulate light at each of, e.g., four wavelengths. The modulation of the modulators 1004 is controlled by the state of the qubit 814 on the quantum processor die 624.

In the embodiment shown, the PIC die 602 may include microring modulators 1004, etc., to perform a readout of four qubits 814. In other embodiments, the PIC die 602 may include components to perform a readout of any suitable number of qubits 814, such as 1-500. In some embodiments, the PIC die 602 may modulate signals on more than one optical fiber 906 or more than one optical fiber core, such as 1-256 optical fibers 906, each of which may have 1-64 cores.

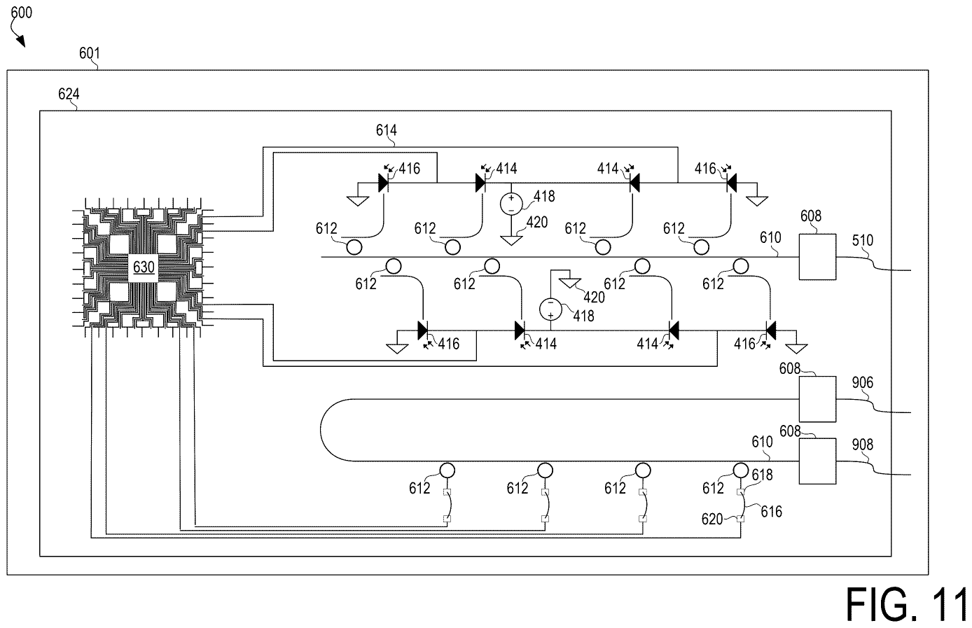

In an illustrative embodiment, some of the components on the quantum processor package 600 are on the PIC die 602, such as the microring modulators 1004 and waveguide 1002, and other components are on a separate quantum processor die 624. In some embodiments, some or all of the components on the PIC die 602 may be integrated into the quantum processor die 624, such as the microring modulators 1004 and waveguide 1002, etc., as shown in FIG. 11.

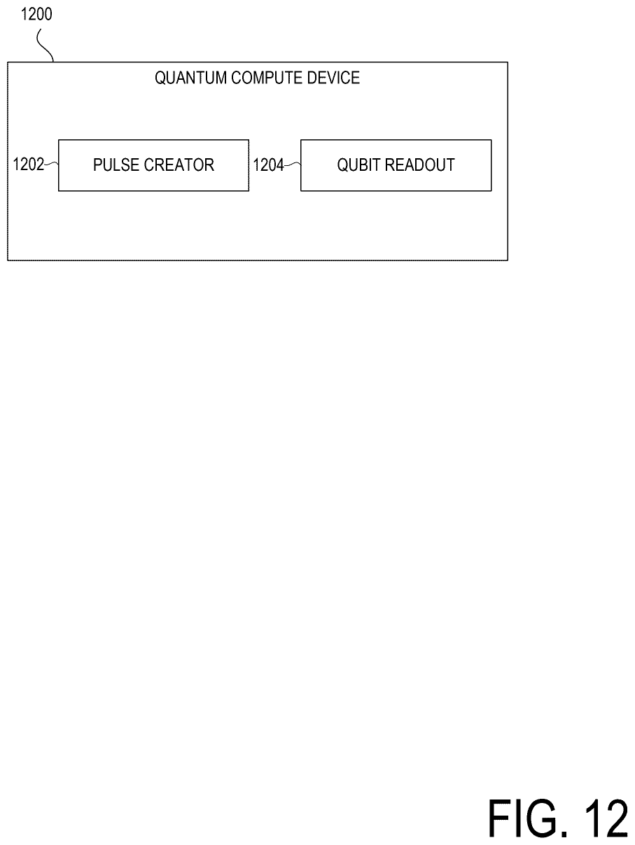

Referring now to FIG. 12, in an illustrative embodiment, the quantum compute device 200 establishes an environment 1200 during operation. The illustrative environment 1200 includes a pulse creator 1202 and qubit readout 1204. The various modules of the environment 1200 may be embodied as hardware, software, firmware, or a combination thereof. For example, the various modules, logic, and other components of the environment 1200 may form a portion of, or otherwise be established by, the quantum/classical interface circuitry 208, the control circuitry 302, processor 202, the memory 204, data storage, and/or other hardware components of the quantum compute device 200. As such, in some embodiments, one or more of the modules of the environment 1200 may be embodied as circuitry or collection of electrical devices (e.g., pulse creator circuitry, qubit readout circuitry, etc.). It should be appreciated that, in such embodiments, one or more of the circuits (e.g., the pulse creator circuitry, the qubit readout circuitry, etc.) may form a portion of one or more of the processor 202, the memory 204, the data storage, and/or other components of the quantum compute device 200. For example, in some embodiments, some or all of the modules may be embodied as the quantum/classical interface circuitry 208, the control circuitry 302, the processor 202, the memory 204, and/or data storage storing instructions to be executed by the quantum/classical interface circuitry 208, the control circuitry 302, and/or the processor 202. Additionally, in some embodiments, one or more of the illustrative modules may form a portion of another module and/or one or more of the illustrative modules may be independent of one another. Further, in some embodiments, one or more of the modules of the environment 1200 may be embodied as virtualized hardware components or emulated architecture, which may be established and maintained by the quantum/classical interface circuitry 208, the control circuitry 302, the processor 202 and/or other components of the quantum compute device 200. It should be appreciated that some of the functionality of one or more of the modules of the environment 1200 may require a hardware implementation, in which case embodiments of modules that implement such functionality will be embodied at least partially as hardware.

The pulse creator 1202 determines when a voltage on a qubit gate 424 should be changed. The pulse creator 1202 controls a laser 402 and modulator 404 to send an optical pulse to a photodiode 414 whose anode is coupled to the qubit gate 424 to increase the voltage on the qubit gate 424, and the pulse creator 1202 controls a laser 402 and modulator 404 to send an optical pulse to a photodiode 416 whose cathode is coupled to the qubit gate 424 to decrease the voltage on the qubit gate 424.

The qubit readout 1204 is to determine when a qubit readout should be performed and perform the readout. The qubit readout 1204 controls a laser 802 that is coupled to a modulator 804 in the cryogenic stage of the quantum compute device 200. The qubit readout 1204 may control coupling of a single-electron transistor 812 to a qubit 814. The output of the single-electron transistor 812 is coupled to the modulator 804, modulating the signal from the laser 802 based on the state of the qubit 814. The modulated signal from the laser 802 is routed back out of the cryogenic state and detected, allowing for the state of the qubit 814 to be detected.

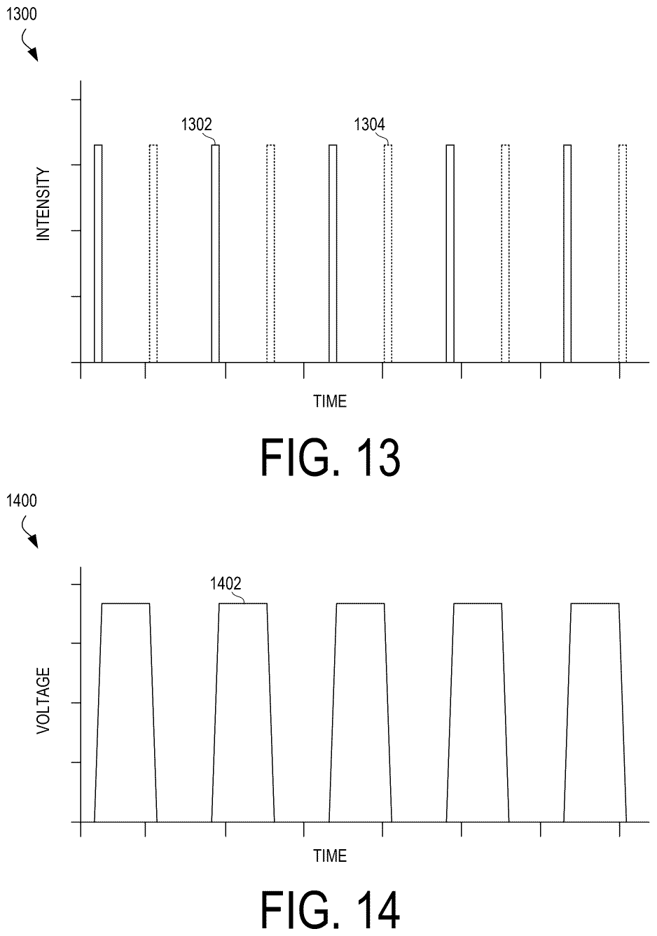

Referring now to FIGS. 13 and 14, in one embodiment, plots 1300 and 1400 show the intensity of laser pulses on the photodiodes 414, 416 and the resulting voltage on a qubit gate 424. Trace 1302 shows the intensity of laser pulses on the photodiode 414, trace 1304 shows the intensity of laser pulses on the photodiode 416, and trace 1402 shows the voltage on the qubit gate 424.

As shown in the plots 1300, 1400, when a laser pulse is incident on the photodiode 414, the voltage on the qubit gate 424 increases. When a laser pulse is incident on the photodiode 416, the voltage on the qubit gate 424 decreases. In this manner, the voltage on the quantum gate can be controlled optically. In an illustrative embodiment, the charge and discharge time of the voltage on the qubit gate 424 is about 1 nanosecond. The hold time for the voltage on the qubit gate 424 may be any suitable time, such as 1-10 nanoseconds or longer.

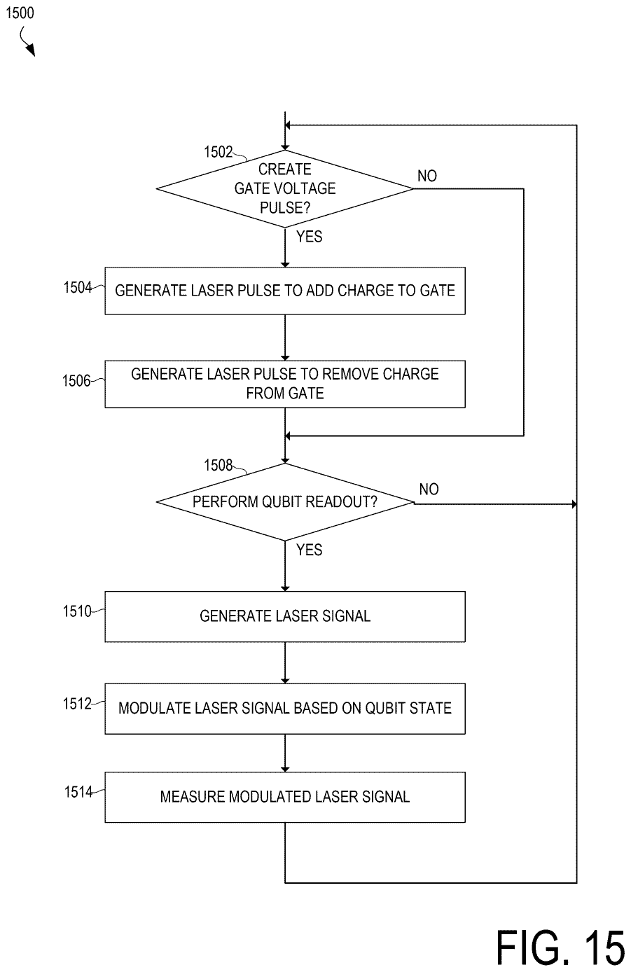

Referring now to FIG. 15, in one embodiment, a flowchart for a method 1500 for controlling quantum gate voltages and performing qubit readout is shown. The method 1500 may be performed by components of the quantum compute device 200, such as the processor 202, the memory 204, the quantum/classical interface circuitry 208, the control circuitry 302, etc. In an illustrative embodiment, the quantum compute device 200 executes the method 1500 as part of performing operations and readout on various qubits.

The method 1500 begins in block 1502, in which the quantum compute device 200 determines whether to create a gate voltage pulse. If the method 1500 is to create a gate voltage pulse, the method 1500 proceeds to block 1504, in which the quantum compute device 200 generates a laser pulse to add charge to the qubit gate 424, by illuminating a photodiode 414 whose anode is electrically coupled to the qubit gate 424. The amplitude of the pulse controls the voltage slew rate on the qubit gate 424, and the total energy of the pulse controls the voltage increase on the qubit gate 424.

In an illustrative embodiment, the quantum compute device 200 then returns the qubit gate 424 to a baseline voltage. To do so, in block 1506, the quantum compute device 200 generates a laser pulse to remove charge from the qubit gate 424, by illuminating a photodiode 414 whose cathode is electrically coupled to the qubit gate 424. In some embodiments, the quantum compute device 200 may hold the voltage at a qubit gate 424 for a period of time, without necessarily returning the voltage on the quantum gate to a baseline voltage.

Returning to block 1502, if the quantum compute device 200 is not to create a gate voltage pulse, the method 1500 jumps forward to block 1508, in which the quantum compute device 200 determines whether to perform a qubit readout. If so, the method 1500 proceeds to block 1510, in which the quantum compute device 200 generates a readout laser signal. The readout laser signal is sent to the quantum processor package 600.

In block 1512, the quantum processor package 600 modulates the laser signal based on the state of a qubit 814. In an illustrative embodiment, the resistance of a single-electron transistor 812 coupled to the qubit 814 depends on the state of the qubit. The voltage output of the single-electron transistor 812 is used to drive a modulator that modulates the intensity of the laser signal, which is routed out of the cryogenic stage. In block 1514, the modulated laser signal is measured, which also measures the state of the qubit 814.

Referring back to block 1508, if a qubit readout is not to be performed, the method 1500 jumps back to block 1502, to check whether a gate voltage pulse should be applied.

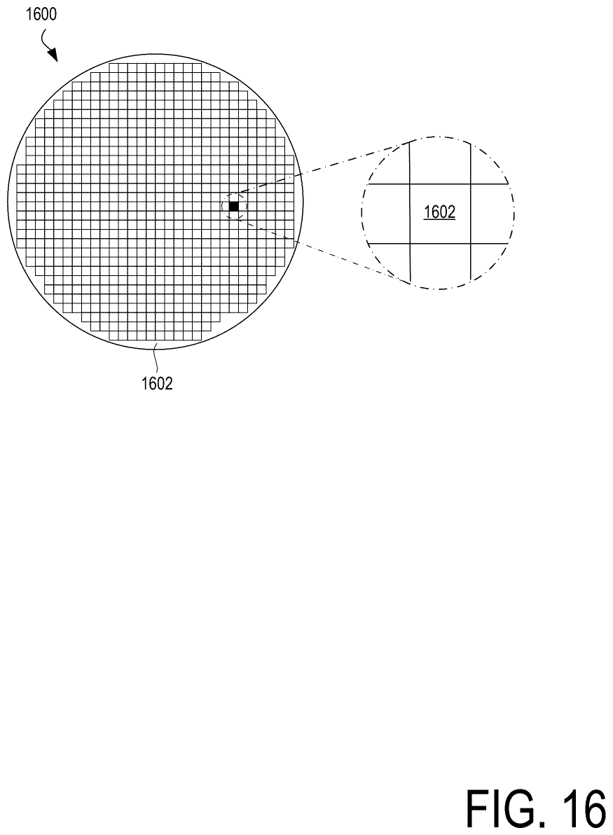

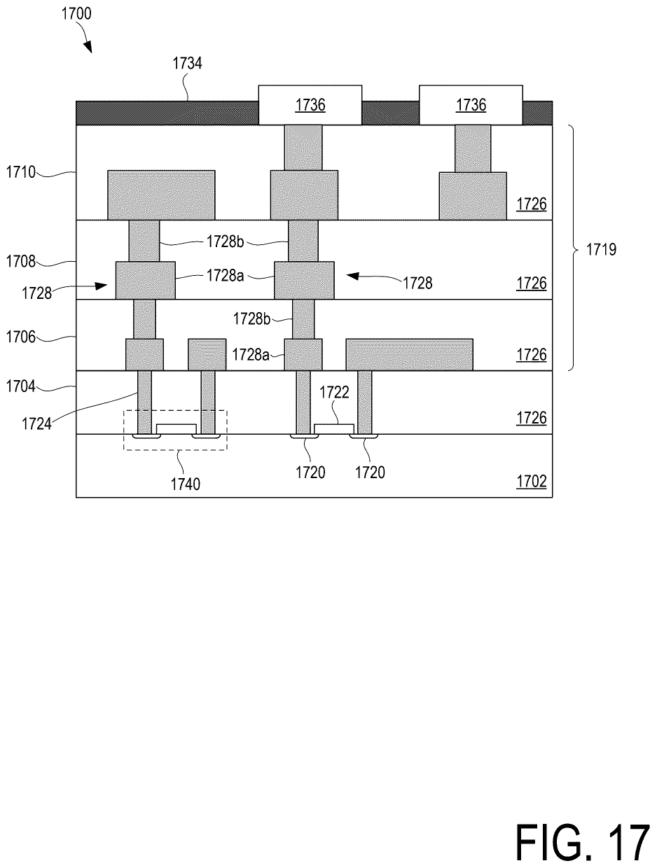

FIG. 16 is a top view of a wafer 1600 and dies 1602 that may be included in any of the integrated circuit components 500, 900 or quantum processor packages 600 disclosed herein (e.g., as any suitable ones of the dies 502, 504, 602, 624, 902, 904). The wafer 1600 may be composed of semiconductor material and may include one or more dies 1602 having integrated circuit structures formed on a surface of the wafer 1600. The individual dies 1602 may be a repeating unit of an integrated circuit product that includes any suitable integrated circuit. After the fabrication of the semiconductor product is complete, the wafer 1600 may undergo a singulation process in which the dies 1602 are separated from one another to provide discrete “chips” of the integrated circuit product. The die 1602 may be any of the dies 502, 504, 602, 624, 902, 904 disclosed herein. The die 1602 may include one or more transistors (e.g., some of the transistors 1740 of FIG. 17, discussed below), supporting circuitry to route electrical signals to the transistors, passive components (e.g., signal traces, resistors, capacitors, or inductors), and/or any other integrated circuit components. In some embodiments, the wafer 1600 or the die 1602 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1602. For example, a memory array formed by multiple memory devices may be formed on a same die 1602 as a processor unit (e.g., the processor unit 2002 of FIG. 20) or other logic that is configured to store information in the memory devices or execute instructions stored in the memory array. Various ones of the integrated circuit components 500, 900 or quantum processor packages 600 disclosed herein may be manufactured using a die-to-wafer assembly technique in which some dies 502, 504, 602, 624, 902, 904 are attached to a wafer 1600 that include others of the dies 502, 504, 602, 624, 902, 904, and the wafer 1600 is subsequently singulated.

FIG. 17 is a cross-sectional side view of an integrated circuit device 1700 that may be included in any of the integrated circuit components 500, 900 or quantum processor packages 600 disclosed herein (e.g., in any of the dies 502, 504, 602, 624, 902, 904). One or more of the integrated circuit devices 1700 may be included in one or more dies 1602 (FIG. 16). The integrated circuit device 1700 may be formed on a die substrate 1702 (e.g., the wafer 1600 of FIG. 16) and may be included in a die (e.g., the die 1602 of FIG. 16). The die substrate 1702 may be a semiconductor substrate composed of semiconductor material systems including, for example, n-type or p-type materials systems (or a combination of both). The die substrate 1702 may include, for example, a crystalline substrate formed using a bulk silicon or a silicon-on-insulator (SOI) substructure. In some embodiments, the die substrate 1702 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1702. Although a few examples of materials from which the die substrate 1702 may be formed are described here, any material that may serve as a foundation for an integrated circuit device 1700 may be used. The die substrate 1702 may be part of a singulated die (e.g., the dies 1602 of FIG. 16) or a wafer (e.g., the wafer 1600 of FIG. 16).

The integrated circuit device 1700 may include one or more device layers 1704 disposed on the die substrate 1702. The device layer 1704 may include features of one or more transistors 1740 (e.g., metal oxide semiconductor field-effect transistors (MOSFETs)) formed on the die substrate 1702. The transistors 1740 may include, for example, one or more source and/or drain (S/D) regions 1720, a gate 1722 to control current flow between the S/D regions 1720, and one or more S/D contacts 1724 to route electrical signals to/from the S/D regions 1720. The transistors 1740 may include additional features not depicted for the sake of clarity, such as device isolation regions, gate contacts, and the like. The transistors 1740 are not limited to the type and configuration depicted in FIG. 17 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

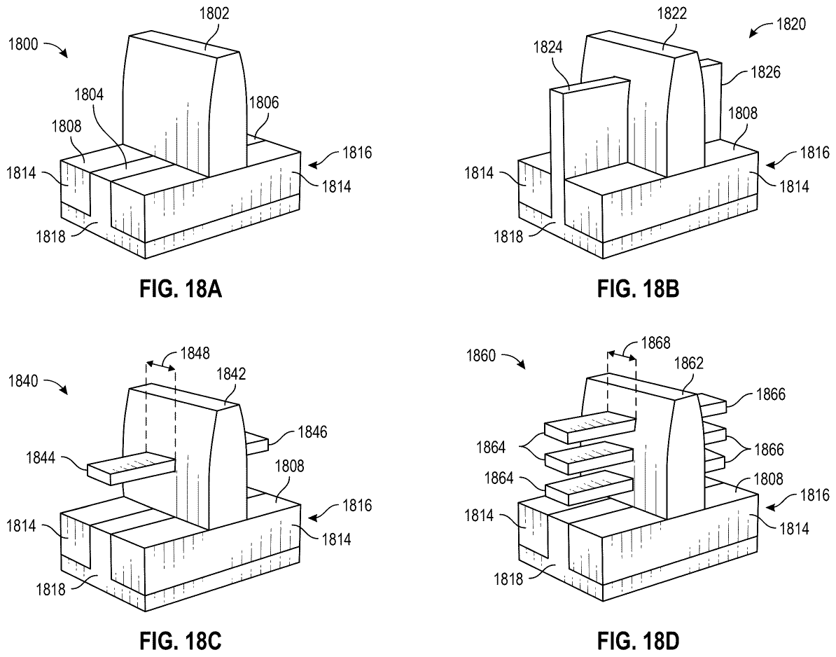

FIGS. 18A-18D are simplified perspective views of example planar, FinFET, gate-all-around, and stacked gate-all-around transistors. The transistors illustrated in FIGS. 18A-18D are formed on a substrate 1816 having a surface 1808. Isolation regions 1814 separate the source and drain regions of the transistors from other transistors and from a bulk region 1818 of the substrate 1816.

FIG. 18A is a perspective view of an example planar transistor 1800 comprising a gate 1802 that controls current flow between a source region 1804 and a drain region 1806. The transistor 1800 is planar in that the source region 1804 and the drain region 1806 are planar with respect to the substrate surface 1808.

FIG. 18B is a perspective view of an example FinFET transistor 1820 comprising a gate 1822 that controls current flow between a source region 1824 and a drain region 1826. The transistor 1820 is non-planar in that the source region 1824 and the drain region 1826 comprise “fins” that extend upwards from the substrate surface 1828. As the gate 1822 encompasses three sides of the semiconductor fin that extends from the source region 1824 to the drain region 1826, the transistor 1820 can be considered a tri-gate transistor. FIG. 18B illustrates one S/D fin extending through the gate 1822, but multiple S/D fins can extend through the gate of a FinFET transistor.

FIG. 18C is a perspective view of a gate-all-around (GAA) transistor 1840 comprising a gate 1842 that controls current flow between a source region 1844 and a drain region 1846. The transistor 1840 is non-planar in that the source region 1844 and the drain region 1846 are elevated from the substrate surface 1828.

FIG. 18D is a perspective view of a GAA transistor 1860 comprising a gate 1862 that controls current flow between multiple elevated source regions 1864 and multiple elevated drain regions 1866. The transistor 1860 is a stacked GAA transistor as the gate controls the flow of current between multiple elevated S/D regions stacked on top of each other. The transistors 1840 and 1860 are considered gate-all-around transistors as the gates encompass all sides of the semiconductor portions that extends from the source regions to the drain regions. The transistors 1840 and 1860 can alternatively be referred to as nanowire, nanosheet, or nanoribbon transistors depending on the width (e.g., widths 1848 and 1868 of transistors 1840 and 1860, respectively) of the semiconductor portions extending through the gate.

Returning to FIG. 17, a transistor 1740 may include a gate 1722 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1740 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1740 along the source-channel-drain direction, the gate electrode may consist of a U-shaped structure that includes a bottom portion substantially parallel to the surface of the die substrate 1702 and two sidewall portions that are substantially perpendicular to the top surface of the die substrate 1702. In other embodiments, at least one of the metal layers that form the gate electrode may simply be a planar layer that is substantially parallel to the top surface of the die substrate 1702 and does not include sidewall portions substantially perpendicular to the top surface of the die substrate 1702. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1720 may be formed within the die substrate 1702 adjacent to the gate 1722 of individual transistors 1740. The S/D regions 1720 may be formed using an implantation/diffusion process or an etching/deposition process, for example. In the former process, dopants such as boron, aluminum, antimony, phosphorous, or arsenic may be ion-implanted into the die substrate 1702 to form the S/D regions 1720. An annealing process that activates the dopants and causes them to diffuse farther into the die substrate 1702 may follow the ion-implantation process. In the latter process, the die substrate 1702 may first be etched to form recesses at the locations of the S/D regions 1720. An epitaxial deposition process may then be carried out to fill the recesses with material that is used to fabricate the S/D regions 1720. In some implementations, the S/D regions 1720 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1720 may be formed using one or more alternate semiconductor materials such as germanium or a group III-V material or alloy. In further embodiments, one or more layers of metal and/or metal alloys may be used to form the S/D regions 1720.

Electrical signals, such as power and/or input/output (I/O) signals, may be routed to and/or from the devices (e.g., transistors 1740) of the device layer 1704 through one or more interconnect layers disposed on the device layer 1704 (illustrated in FIG. 17 as interconnect layers 1706-1710). For example, electrically conductive features of the device layer 1704 (e.g., the gate 1722 and the S/D contacts 1724) may be electrically coupled with the interconnect structures 1728 of the interconnect layers 1706-1710. The one or more interconnect layers 1706-1710 may form a metallization stack (also referred to as an “ILD stack”) 1719 of the integrated circuit device 1700.

The interconnect structures 1728 may be arranged within the interconnect layers 1706-1710 to route electrical signals according to a wide variety of designs; in particular, the arrangement is not limited to the particular configuration of interconnect structures 1728 depicted in FIG. 17. Although a particular number of interconnect layers 1706-1710 is depicted in FIG. 17, embodiments of the present disclosure include integrated circuit devices having more or fewer interconnect layers than depicted.

In some embodiments, the interconnect structures 1728 may include lines 1728a and/or vias 1728b filled with an electrically conductive material such as a metal. The lines 1728a may be arranged to route electrical signals in a direction of a plane that is substantially parallel with a surface of the die substrate 1702 upon which the device layer 1704 is formed. For example, the lines 1728a may route electrical signals in a direction in and out of the page and/or in a direction across the page. The vias 1728b may be arranged to route electrical signals in a direction of a plane that is substantially perpendicular to the surface of the die substrate 1702 upon which the device layer 1704 is formed. In some embodiments, the vias 1728b may electrically couple lines 1728a of different interconnect layers 1706-1710 together.

The interconnect layers 1706-1710 may include a dielectric material 1726 disposed between the interconnect structures 1728, as shown in FIG. 17. In some embodiments, dielectric material 1726 disposed between the interconnect structures 1728 in different ones of the interconnect layers 1706-1710 may have different compositions; in other embodiments, the composition of the dielectric material 1726 between different interconnect layers 1706-1710 may be the same. The device layer 1704 may include a dielectric material 1726 disposed between the transistors 1740 and a bottom layer of the metallization stack as well. The dielectric material 1726 included in the device layer 1704 may have a different composition than the dielectric material 1726 included in the interconnect layers 1706-1710; in other embodiments, the composition of the dielectric material 1726 in the device layer 1704 may be the same as a dielectric material 1726 included in any one of the interconnect layers 1706-1710.

A first interconnect layer 1706 (referred to as Metal 1 or “M1”) may be formed directly on the device layer 1704. In some embodiments, the first interconnect layer 1706 may include lines 1728a and/or vias 1728b, as shown. The lines 1728a of the first interconnect layer 1706 may be coupled with contacts (e.g., the S/D contacts 1724) of the device layer 1704. The vias 1728b of the first interconnect layer 1706 may be coupled with the lines 1728a of a second interconnect layer 1708.

The second interconnect layer 1708 (referred to as Metal 2 or “M2”) may be formed directly on the first interconnect layer 1706. In some embodiments, the second interconnect layer 1708 may include via 1728b to couple the lines 1728 of the second interconnect layer 1708 with the lines 1728a of a third interconnect layer 1710. Although the lines 1728a and the vias 1728b are structurally delineated with a line within individual interconnect layers for the sake of clarity, the lines 1728a and the vias 1728b may be structurally and/or materially contiguous (e.g., simultaneously filled during a dual-damascene process) in some embodiments.

The third interconnect layer 1710 (referred to as Metal 3 or “M3”) (and additional interconnect layers, as desired) may be formed in succession on the second interconnect layer 1708 according to similar techniques and configurations described in connection with the second interconnect layer 1708 or the first interconnect layer 1706. In some embodiments, the interconnect layers that are “higher up” in the metallization stack 1719 in the integrated circuit device 1700 (i.e., farther away from the device layer 1704) may be thicker that the interconnect layers that are lower in the metallization stack 1719, with lines 1728a and vias 1728b in the higher interconnect layers being thicker than those in the lower interconnect layers.

The integrated circuit device 1700 may include a solder resist material 1734 (e.g., polyimide or similar material) and one or more conductive contacts 1736 formed on the interconnect layers 1706-1710. In FIG. 17, the conductive contacts 1736 are illustrated as taking the form of bond pads. The conductive contacts 1736 may be electrically coupled with the interconnect structures 1728 and configured to route the electrical signals of the transistor(s) 1740 to external devices. For example, solder bonds may be formed on the one or more conductive contacts 1736 to mechanically and/or electrically couple an integrated circuit die including the integrated circuit device 1700 with another component (e.g., a printed circuit board). The integrated circuit device 1700 may include additional or alternate structures to route the electrical signals from the interconnect layers 1706-1710; for example, the conductive contacts 1736 may include other analogous features (e.g., posts) that route the electrical signals to external components. The conductive contacts 1736 may serve as the pads 618, 620, 628, as appropriate.

In some embodiments in which the integrated circuit device 1700 is a double-sided die, the integrated circuit device 1700 may include another metallization stack (not shown) on the opposite side of the device layer(s) 1704. This metallization stack may include multiple interconnect layers as discussed above with reference to the interconnect layers 1706-1710, to provide conductive pathways (e.g., including conductive lines and vias) between the device layer(s) 1704 and additional conductive contacts (not shown) on the opposite side of the integrated circuit device 1700 from the conductive contacts 1736. These additional conductive contacts may serve as the pads 618, 620, 628, as appropriate.

In other embodiments in which the integrated circuit device 1700 is a double-sided die, the integrated circuit device 1700 may include one or more through silicon vias (TSVs) through the die substrate 1702; these TSVs may make contact with the device layer(s) 1704, and may provide conductive pathways between the device layer(s) 1704 and additional conductive contacts (not shown) on the opposite side of the integrated circuit device 1700 from the conductive contacts 1736. These additional conductive contacts may serve as the pads 618, 620, 628, as appropriate. In some embodiments, TSVs extending through the substrate can be used for routing power and ground signals from conductive contacts on the opposite side of the integrated circuit device 1700 from the conductive contacts 1736 to the transistors 1740 and any other components integrated into the die, and the metallization stack 1719 can be used to route I/O signals from the conductive contacts 1736 to transistors 1740 and any other components integrated into the die.

Multiple integrated circuit devices 1700 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

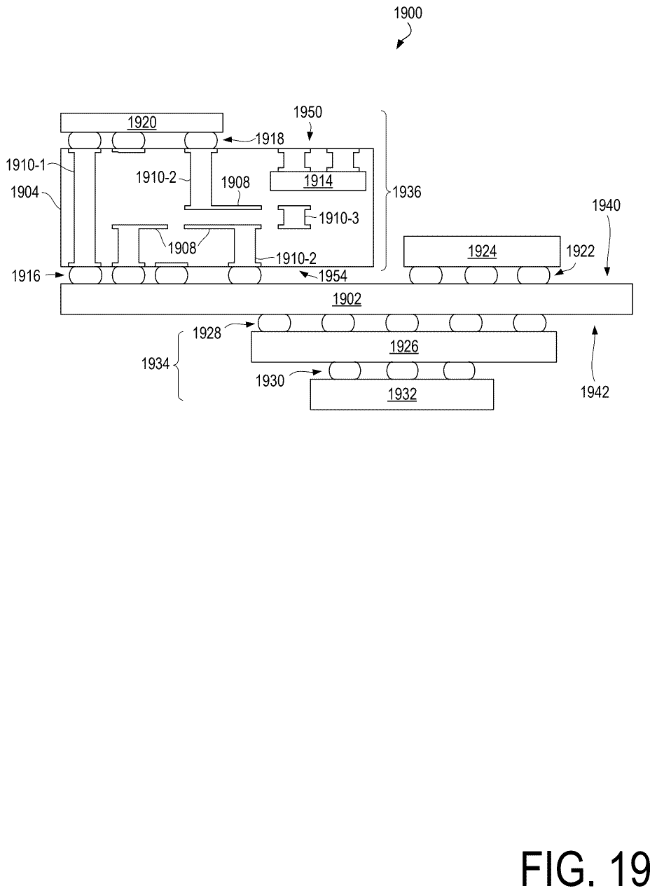

FIG. 19 is a cross-sectional side view of an integrated circuit device assembly 1900 that may include any of the integrated circuit components 500, 900 or quantum processor packages 600 disclosed herein. In some embodiments, the integrated circuit device assembly 1900 may be a integrated circuit components 500, 900 or quantum processor packages 600. The integrated circuit device assembly 1900 includes a number of components disposed on a circuit board 1902 (which may be a motherboard, system board, mainboard, etc.). The integrated circuit device assembly 1900 includes components disposed on a first face 1940 of the circuit board 1902 and an opposing second face 1942 of the circuit board 1902; generally, components may be disposed on one or both faces 1940 and 1942. Any of the integrated circuit components discussed below with reference to the integrated circuit device assembly 1900 may take the form of any suitable ones of the embodiments of the integrated circuit components 500, 900 or quantum processor packages 600 disclosed herein.

In some embodiments, the circuit board 1902 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1902. In other embodiments, the circuit board 1902 may be a non-PCB substrate. In some embodiments the circuit board 1902 may be, for example, the circuit board 501, 601, 901. The integrated circuit device assembly 1900 illustrated in FIG. 19 includes a package-on-interposer structure 1936 coupled to the first face 1940 of the circuit board 1902 by coupling components 1916. The coupling components 1916 may electrically and mechanically couple the package-on-interposer structure 1936 to the circuit board 1902, and may include solder balls (as shown in FIG. 19), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1916 may serve as the coupling components illustrated or described for any of the substrate assembly or substrate assembly components described herein, as appropriate.

The package-on-interposer structure 1936 may include an integrated circuit component 1920 coupled to an interposer 1904 by coupling components 1918. The coupling components 1918 may take any suitable form for the application, such as the forms discussed above with reference to the coupling components 1916. Although a single integrated circuit component 1920 is shown in FIG. 19, multiple integrated circuit components may be coupled to the interposer 1904; indeed, additional interposers may be coupled to the interposer 1904. The interposer 1904 may provide an intervening substrate used to bridge the circuit board 1902 and the integrated circuit component 1920.

The integrated circuit component 1920 may be a packaged or unpacked integrated circuit product that includes one or more integrated circuit dies (e.g., the die 1602 of FIG. 16, the integrated circuit device 1700 of FIG. 17) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1920, a single monolithic integrated circuit die comprises solder bumps attached to contacts on the die. The solder bumps allow the die to be directly attached to the interposer 1904. The integrated circuit component 1920 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1920 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1920 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1920 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1904 may spread connections to a wider pitch or reroute a connection to a different connection. For example, the interposer 1904 may couple the integrated circuit component 1920 to a set of ball grid array (BGA) conductive contacts of the coupling components 1916 for coupling to the circuit board 1902. In the embodiment illustrated in FIG. 19, the integrated circuit component 1920 and the circuit board 1902 are attached to opposing sides of the interposer 1904; in other embodiments, the integrated circuit component 1920 and the circuit board 1902 may be attached to a same side of the interposer 1904. In some embodiments, three or more components may be interconnected by way of the interposer 1904.

In some embodiments, the interposer 1904 may be formed as a PCB, including multiple metal layers separated from one another by layers of dielectric material and interconnected by electrically conductive vias. In some embodiments, the interposer 1904 may be formed of an epoxy resin, a fiberglass-reinforced epoxy resin, an epoxy resin with inorganic fillers, a ceramic material, or a polymer material such as polyimide. In some embodiments, the interposer 1904 may be formed of alternate rigid or flexible materials that may include the same materials described above for use in a semiconductor substrate, such as silicon, germanium, and other group III-V and group IV materials. The interposer 1904 may include metal interconnects 1908 and vias 1910, including but not limited to through hole vias 1910-1 (that extend from a first face 1950 of the interposer 1904 to a second face 1954 of the interposer 1904), blind vias 1910-2 (that extend from the first or second faces 1950 or 1954 of the interposer 1904 to an internal metal layer), and buried vias 1910-3 (that connect internal metal layers).

In some embodiments, the interposer 1904 can comprise a silicon interposer. Through silicon vias (TSV) extending through the silicon interposer can connect connections on a first face of a silicon interposer to an opposing second face of the silicon interposer. In some embodiments, an interposer 1904 comprising a silicon interposer can further comprise one or more routing layers to route connections on a first face of the interposer 1904 to an opposing second face of the interposer 1904.

The interposer 1904 may further include embedded devices 1914, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1904. The package-on-interposer structure 1936 may take the form of any of the package-on-interposer structures known in the art.

The integrated circuit device assembly 1900 may include an integrated circuit component 1924 coupled to the first face 1940 of the circuit board 1902 by coupling components 1922. The coupling components 1922 may take the form of any of the embodiments discussed above with reference to the coupling components 1916, and the integrated circuit component 1924 may take the form of any of the embodiments discussed above with reference to the integrated circuit component 1920.

The integrated circuit device assembly 1900 illustrated in FIG. 19 includes a package-on-package structure 1934 coupled to the second face 1942 of the circuit board 1902 by coupling components 1928. The package-on-package structure 1934 may include an integrated circuit component 1926 and an integrated circuit component 1932 coupled together by coupling components 1930 such that the integrated circuit component 1926 is disposed between the circuit board 1902 and the integrated circuit component 1932. The coupling components 1928 and 1930 may take the form of any of the embodiments of the coupling components 1916 discussed above, and the integrated circuit components 1926 and 1932 may take the form of any of the embodiments of the integrated circuit component 1920 discussed above. The package-on-package structure 1934 may be configured in accordance with any of the package-on-package structures known in the art.

FIG. 20 is a block diagram of an example electrical device 2000 that may include one or more of the integrated circuit components 500, 900 or quantum processor packages 600 disclosed herein. For example, any suitable ones of the components of the electrical device 2000 may include one or more of the integrated circuit device assemblies 1900, integrated circuit components 1920, integrated circuit devices 1700, or integrated circuit dies 1602 disclosed herein, and may be arranged in any of the integrated circuit components 500, 900 or quantum processor packages 600 disclosed herein. A number of components are illustrated in FIG. 20 as included in the electrical device 2000, but any one or more of these components may be omitted or duplicated, as suitable for the application. In some embodiments, some or all of the components included in the electrical device 2000 may be attached to one or more motherboards mainboards, or system boards. In some embodiments, one or more of these components are fabricated onto a single system-on-a-chip (SoC) die.

Additionally, in various embodiments, the electrical device 2000 may not include one or more of the components illustrated in FIG. 20, but the electrical device 2000 may include interface circuitry for coupling to the one or more components. For example, the electrical device 2000 may not include a display device 2006, but may include display device interface circuitry (e.g., a connector and driver circuitry) to which a display device 2006 may be coupled. In another set of examples, the electrical device 2000 may not include an audio input device 2024 or an audio output device 2008, but may include audio input or output device interface circuitry (e.g., connectors and supporting circuitry) to which an audio input device 2024 or audio output device 2008 may be coupled.

The electrical device 2000 may include one or more processor units 2002 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 2002 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 2000 may include a memory 2004, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 2004 may include memory that is located on the same integrated circuit die as the processor unit 2002. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 2000 can comprise one or more processor units 2002 that are heterogeneous or asymmetric to another processor unit 2002 in the electrical device 2000. There can be a variety of differences between the processing units 2002 in a system in terms of a spectrum of metrics of merit including architectural, microarchitectural, thermal, power consumption characteristics, and the like. These differences can effectively manifest themselves as asymmetry and heterogeneity among the processor units 2002 in the electrical device 2000.

In some embodiments, the electrical device 2000 may include a communication component 2012 (e.g., one or more communication components). For example, the communication component 2012 can manage wireless communications for the transfer of data to and from the electrical device 2000. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 2012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 2012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 2012 may operate in accordance with other wireless protocols in other embodiments. The electrical device 2000 may include an antenna 2022 to facilitate wireless communications and/or to receive other wireless communications (such as AM or FM radio transmissions).

In some embodiments, the communication component 2012 may manage wired communications, such as electrical, optical, or any other suitable communication protocols (e.g., IEEE 802.3 Ethernet standards). As noted above, the communication component 2012 may include multiple communication components. For instance, a first communication component 2012 may be dedicated to shorter-range wireless communications such as Wi-Fi or Bluetooth, and a second communication component 2012 may be dedicated to longer-range wireless communications such as global positioning system (GPS), EDGE, GPRS, CDMA, WiMAX, LTE, EV-DO, or others. In some embodiments, a first communication component 2012 may be dedicated to wireless communications, and a second communication component 2012 may be dedicated to wired communications.

The electrical device 2000 may include battery/power circuitry 2014. The battery/power circuitry 2014 may include one or more energy storage devices (e.g., batteries or capacitors) and/or circuitry for coupling components of the electrical device 2000 to an energy source separate from the electrical device 2000 (e.g., AC line power).

The electrical device 2000 may include a display device 2006 (or corresponding interface circuitry, as discussed above). The display device 2006 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 2000 may include an audio output device 2008 (or corresponding interface circuitry, as discussed above). The audio output device 2008 may include any embedded or wired or wirelessly connected external device that generates an audible indicator, such as speakers, headsets, or earbuds.

The electrical device 2000 may include an audio input device 2024 (or corresponding interface circuitry, as discussed above). The audio input device 2024 may include any embedded or wired or wirelessly connected device that generates a signal representative of a sound, such as microphones, microphone arrays, or digital instruments (e.g., instruments having a musical instrument digital interface (MIDI) output). The electrical device 2000 may include a Global Navigation Satellite System (GNSS) device 2018 (or corresponding interface circuitry, as discussed above), such as a Global Positioning System (GPS) device. The GNSS device 2018 may be in communication with a satellite-based system and may determine a geolocation of the electrical device 2000 based on information received from one or more GNSS satellites, as known in the art.

The electrical device 2000 may include an other output device 2010 (or corresponding interface circuitry, as discussed above). Examples of the other output device 2010 may include an audio codec, a video codec, a printer, a wired or wireless transmitter for providing information to other devices, or an additional storage device.

The electrical device 2000 may include an other input device 2020 (or corresponding interface circuitry, as discussed above). Examples of the other input device 2020 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 2000 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 2000 may be any other electronic device that processes data. In some embodiments, the electrical device 2000 may comprise multiple discrete physical components. Given the range of devices that the electrical device 2000 can be manifested as in various embodiments, in some embodiments, the electrical device 2000 can be referred to as a computing device or a computing system.

### EXAMPLES

Illustrative examples of the technologies disclosed herein are provided below. An embodiment of the technologies may include any one or more, and any combination of, the examples described below.

Example 1 includes a system comprising a quantum processor package comprising a qubit gate; a first photodiode, wherein an anode of the first photodiode is electrically coupled to the qubit gate; and a second photodiode, wherein a cathode of the second photodiode is electrically coupled to the qubit gate.

Example 2 includes the subject matter of Example 1, and wherein the quantum processor package further comprises a waveguide; a microring resonator coupled to the waveguide; and a single-electron transistor, wherein an output of the single-electron transistor is coupled to the microring resonator.

Example 3 includes the subject matter of any of Examples 1 and 2, and wherein, in use, the single-electron transistor is coupled to a qubit of the quantum processor package, wherein, in use, the output of the single-electron transistor depends on a state of the qubit.

Example 4 includes the subject matter of any of Examples 1-3, and wherein the microring resonator comprises a p-n junction, wherein the output of the single-electron transistor is coupled to the p-n junction.

Example 5 includes the subject matter of any of Examples 1-4, and wherein the quantum processor package further comprises a second microring resonator coupled to the waveguide; and a second single-electron transistor, wherein an output of the second single-electron transistor is coupled to the second microring resonator, wherein the microring resonator is resonant at a first wavelength, wherein the second microring resonator is resonant at a second wavelength different from the first wavelength.

Example 6 includes the subject matter of any of Examples 1-5, and wherein the quantum processor package comprises a quantum processor die, wherein the quantum processor die comprises the single-electron transistor; and a photonic integrated circuit (PIC) die, wherein the PIC die comprises the waveguide and the microring resonator.

Example 7 includes the subject matter of any of Examples 1-6, and wherein the quantum processor package comprises a quantum processor die, wherein the quantum processor die comprises the single-electron transistor, the waveguide, and the microring resonator.

Example 8 includes the subject matter of any of Examples 1-7, and wherein the quantum processor package further comprises a waveguide; a first microring resonator coupled to the waveguide and the first photodiode; and a second microring resonator coupled to the waveguide and the second photodiode, wherein the first microring resonator is resonant at a first wavelength, wherein the second microring resonator is resonant at a second wavelength different from the first wavelength.

Example 9 includes the subject matter of any of Examples 1-8, and wherein the quantum processor package further comprises a second qubit gate; a third photodiode, wherein an anode of the third photodiode is electrically coupled to the second qubit gate; a fourth photodiode, wherein a cathode of the fourth photodiode is electrically coupled to the second qubit gate; a third microring resonator coupled to the waveguide and the third photodiode; and a fourth microring resonator coupled to the waveguide and the fourth photodiode, wherein the third microring resonator is resonant at a third wavelength different from the first and second wavelengths, wherein the fourth microring resonator is resonant at a fourth wavelength different from the first, second, and third wavelengths.

Example 10 includes the subject matter of any of Examples 1-9, and further including a first laser coupled to the first photodiode; and a second laser coupled to the second photodiode, wherein, in use, a pulse from the first laser is to increase a voltage of the qubit gate, wherein, in use, a pulse from the second laser is to decrease a voltage of the qubit gate.

Example 11 includes the subject matter of any of Examples 1-10, and wherein the quantum processor package is inside a cryogenic refrigerator, wherein the first laser and the second laser are outside of the cryogenic refrigerator.

Example 12 includes the subject matter of any of Examples 1-11, and wherein the pulse from the first laser has a power less than 10 microwatts.

Example 13 includes the subject matter of any of Examples 1-12, and further including quantum/classical interface circuitry to control pulses from the first laser and the second laser, wherein the quantum/classical interface circuitry is to control a voltage on the qubit gate across a range of at least 100 millivolts, wherein the quantum/classical interface circuitry is to control a voltage on the qubit gate with a resolution less than 50 microvolts.

Example 14 includes the subject matter of any of Examples 1-13, and wherein the quantum processor package comprises a quantum processor die, wherein the quantum processor die comprises the qubit gate; and a photonic integrated circuit (PIC) die, wherein the PIC die comprises the first photodiode and the second photodiode.

Example 15 includes the subject matter of any of Examples 1-14, and wherein the quantum processor package comprises a quantum processor die, wherein the quantum processor die comprises the qubit gate, the first photodiode, and the second photodiode.

Example 16 includes the subject matter of any of Examples 1-15, and further including a voltage source to apply a reverse bias on the first photodiode; and a voltage source to apply a reverse bias on the second photodiode.

Example 17 includes a system comprising a quantum processor package comprising a waveguide; a microring resonator coupled to the waveguide; and a single-electron transistor, wherein an output of the single-electron transistor is coupled to the microring resonator.

Example 18 includes the subject matter of Example 17, and wherein, in use, the single-electron transistor is coupled to a qubit of the quantum processor package, wherein, in use, the output of the single-electron transistor depends on a state of the qubit.

Example 19 includes the subject matter of any of Examples 17 and 18, and wherein the microring resonator comprises a p-n junction, wherein the output of the single-electron transistor is coupled to the p-n junction.

Example 20 includes the subject matter of any of Examples 17-19, and wherein the quantum processor package further comprises a second microring resonator coupled to the waveguide; and a second single-electron transistor, wherein an output of the second single-electron transistor is coupled to the second microring resonator, wherein the microring resonator is resonant at a first wavelength, wherein the second microring resonator is resonant at a second wavelength different from the first wavelength.

Example 21 includes the subject matter of any of Examples 17-20, and wherein the quantum processor package comprises a quantum processor die, wherein the quantum processor die comprises the single-electron transistor; and a photonic integrated circuit (PIC) die, wherein the PIC die comprises the waveguide and the microring resonator.

Example 22 includes the subject matter of any of Examples 17-21, and wherein the quantum processor package comprises a quantum processor die, wherein the quantum processor die comprises the single-electron transistor, the waveguide, and the microring resonator.

Example 23 includes the subject matter of any of Examples 17-22, and wherein the quantum processor package further comprises a qubit gate; a first photodiode, wherein an anode of the first photodiode is electrically coupled to the qubit gate; and a second photodiode, wherein a cathode of the second photodiode is electrically coupled to the qubit gate.

Example 24 includes the subject matter of any of Examples 17-23, and wherein the quantum processor package further comprises a second waveguide; a first microring resonator coupled to the second waveguide and the first photodiode; and a second microring resonator coupled to the second waveguide and the second photodiode, wherein the first microring resonator is resonant at a first wavelength, wherein the second microring resonator is resonant at a second wavelength different from the first wavelength.

Example 25 includes the subject matter of any of Examples 17-24, and wherein the quantum processor package further comprises a second qubit gate; a third photodiode, wherein an anode of the third photodiode is electrically coupled to the second qubit gate; a fourth photodiode, wherein a cathode of the fourth photodiode is electrically coupled to the second qubit gate; a third microring resonator coupled to the second waveguide and the third photodiode; and a fourth microring resonator coupled to the second waveguide and the fourth photodiode, wherein the third microring resonator is resonant at a third wavelength different from the first and second wavelengths, wherein the fourth microring resonator is resonant at a fourth wavelength different from the first, second, and third wavelengths.

Example 26 includes the subject matter of any of Examples 17-25, and further including a first laser coupled to the first photodiode; and a second laser coupled to the second photodiode, wherein, in use, a pulse from the first laser is to increase a voltage of the qubit gate, wherein, in use, a pulse from the second laser is to decrease a voltage of the qubit gate.

Example 27 includes the subject matter of any of Examples 17-26, and wherein the quantum processor package is inside a cryogenic refrigerator, wherein the first laser and the second laser are outside of the cryogenic refrigerator.

Example 28 includes the subject matter of any of Examples 17-27, and wherein the pulse from the first laser has a power less than 10 microwatts.

Example 29 includes the subject matter of any of Examples 17-28, and further including quantum/classical interface circuitry to control pulses from the first laser and the second laser, wherein the quantum/classical interface circuitry is to control a voltage on the qubit gate across a range of at least 100 millivolts, wherein the quantum/classical interface circuitry is to control a voltage on the qubit gate with a resolution less than 50 microvolts.

Example 30 includes the subject matter of any of Examples 17-29, and wherein the quantum processor package comprises a quantum processor die, wherein the quantum processor die comprises the qubit gate; and a photonic integrated circuit (PIC) die, wherein the PIC die comprises the first photodiode and the second photodiode.

Example 31 includes the subject matter of any of Examples 17-30, and wherein the quantum processor package comprises a quantum processor die, wherein the quantum processor die comprises the qubit gate, the first photodiode, and the second photodiode.

Example 32 includes the subject matter of any of Examples 17-31, and further including a voltage source to apply a reverse bias on the first photodiode; and a voltage source to apply a reverse bias on the second photodiode.

Example 33 includes a system comprising a quantum processor package, wherein the quantum processor package comprises a plurality of qubit gates to interface with a plurality of spin qubits; and means for optically controlling a voltage of individual gates of the plurality of qubit gates.

Example 34 includes the subject matter of Example 33, and further including means for optically measuring a state of individual spin qubits of the plurality of spin qubits.

1. A system comprising:
a quantum processor package comprising:
a qubit gate;
a first photodiode, wherein an anode of the first photodiode is electrically coupled to the qubit gate; and
a second photodiode, wherein a cathode of the second photodiode is electrically coupled to the qubit gate.

2. The system of claim 1, the quantum processor package further comprising:
a waveguide;
a microring resonator coupled to the waveguide; and
a single-electron transistor, wherein an output of the single-electron transistor is coupled to the microring resonator.

3. The system of claim 1, wherein the quantum processor package further comprises:
a waveguide;
a first microring resonator coupled to the waveguide and the first photodiode; and
a second microring resonator coupled to the waveguide and the second photodiode,
wherein the first microring resonator is resonant at a first wavelength, wherein the second microring resonator is resonant at a second wavelength different from the first wavelength.

4. The system of claim 3, wherein the quantum processor package further comprises:
a second qubit gate;
a third photodiode, wherein an anode of the third photodiode is electrically coupled to the second qubit gate;
a fourth photodiode, wherein a cathode of the fourth photodiode is electrically coupled to the second qubit gate;
a third microring resonator coupled to the waveguide and the third photodiode; and
a fourth microring resonator coupled to the waveguide and the fourth photodiode,
wherein the third microring resonator is resonant at a third wavelength different from the first and second wavelengths, wherein the fourth microring resonator is resonant at a fourth wavelength different from the first, second, and third wavelengths.

5. The system of claim 1, further comprising:
a first laser coupled to the first photodiode; and
a second laser coupled to the second photodiode,
wherein, in use, a pulse from the first laser is to increase a voltage of the qubit gate,
wherein, in use, a pulse from the second laser is to decrease a voltage of the qubit gate.

6. The system of claim 5, wherein the quantum processor package is inside a cryogenic refrigerator, wherein the first laser and the second laser are outside of the cryogenic refrigerator.

7. The system of claim 5, wherein the pulse from the first laser has a power less than microwatts.

8. The system of claim 5, further comprising:
quantum/classical interface circuitry to control pulses from the first laser and the second laser,
wherein the quantum/classical interface circuitry is to control a voltage on the qubit gate across a range of at least 100 millivolts, wherein the quantum/classical interface circuitry is to control a voltage on the qubit gate with a resolution less than 50 microvolts.

9. The system of claim 1, wherein the quantum processor package comprises:
a quantum processor die, wherein the quantum processor die comprises the qubit gate; and
a photonic integrated circuit (PIC) die, wherein the PIC die comprises the first photodiode and the second photodiode.

10. The system of claim 1, wherein the quantum processor package comprises:
a quantum processor die, wherein the quantum processor die comprises the qubit gate, the first photodiode, and the second photodiode.

11. The system of claim 1, further comprising:
a voltage source to apply a reverse bias on the first photodiode; and
a voltage source to apply a reverse bias on the second photodiode.

12. A system comprising:
a quantum processor package comprising:
a waveguide;
a microring resonator coupled to the waveguide; and
a single-electron transistor, wherein an output of the single-electron transistor is coupled to the microring resonator.

13. The system of claim 12, wherein, in use, the single-electron transistor is coupled to a qubit of the quantum processor package, wherein, in use, the output of the single-electron transistor depends on a state of the qubit.

14. The system of claim 12, wherein the microring resonator comprises a p-n junction, wherein the output of the single-electron transistor is coupled to the p-n junction.

15. The system of claim 12, wherein the quantum processor package further comprises:
a second microring resonator coupled to the waveguide; and
a second single-electron transistor, wherein an output of the second single-electron transistor is coupled to the second microring resonator,
wherein the microring resonator is resonant at a first wavelength, wherein the second microring resonator is resonant at a second wavelength different from the first wavelength.

16. The system of claim 12, wherein the quantum processor package comprises:
a quantum processor die, wherein the quantum processor die comprises the single-electron transistor; and
a photonic integrated circuit (PIC) die, wherein the PIC die comprises the waveguide and the microring resonator.

17. The system of claim 12, wherein the quantum processor package comprises:
a quantum processor die, wherein the quantum processor die comprises the single-electron transistor, the waveguide, and the microring resonator.

18. The system of claim 12, wherein the quantum processor package further comprises:
a qubit gate;
a first photodiode, wherein an anode of the first photodiode is electrically coupled to the qubit gate; and
a second photodiode, wherein a cathode of the second photodiode is electrically coupled to the qubit gate.

19. A system comprising:
a quantum processor package, wherein the quantum processor package comprises a plurality of qubit gates to interface with a plurality of spin qubits; and
means for optically controlling a voltage of individual gates of the plurality of qubit gates.

20. The system of claim 19, further comprising means for optically measuring a state of individual spin qubits of the plurality of spin qubits.
